(19) United States
(12) Patent Application Publication
(10) Pub. No.: US 2024/0404184 A1
(43) Pub. Date: Dec. 5, 2024

(54) IMAGE PROCESSING APPARATUS, IMAGE PROCESSING METHOD, AND PROGRAM

(71) Applicant: FUJIFILM Corporation, Tokyo (JP)

(72) Inventor: Yasuhiko KANEKO, Kanagawa (JP)

(73) Assignee: FUJIFILM Corporation, Tokyo (JP)

(21) Appl. No.: 18/801,848

(22) Filed: Aug. 13, 2024

Related U.S. Application Data
(63) Continuation of application No. PCT/JP2022/041770, filed on Nov. 9, 2022.

(30) Foreign Application Priority Data
Mar. 29, 2022 (JP) 2022-053388

(51) Int. Cl. G06T 15/20

(52) U.S. Cl. CPC G06T 15/205

(57) ABSTRACT

An image processing apparatus includes a processor. The processor is configured to: display, on a screen, a plurality of two-dimensional images that are used to generate a three-dimensional image showing a target object in a real space and that are associated with a plurality of portions of the three-dimensional image, and the three-dimensional image in a state in which the plurality of two-dimensional images and the three-dimensional image are comparable with each other; select a two-dimensional image of interest from among the plurality of two-dimensional images in response to a given selection instruction; and display, on the screen, a portion of interest corresponding to the two-dimensional image of interest among the plurality of portions in a state in which the portion of interest is visually specifiable.

This application is a continuation application of International Application No. PCT/JP2022/041770, filed Nov. 9, 2022, the disclosure of which is incorporated herein by reference in its entirety. Further, this application claims priority under 35 USC 119 from Japanese Patent Application No. 2022-053388 filed Mar. 29, 2022, the disclosure of which is incorporated by reference herein.

### BACKGROUND OF THE INVENTION

### 1. Field of the Invention

The technology of the present disclosure relates to an image processing apparatus, an image processing method, and a program.

### 2. Description of the Related Art

JP2020-005186A discloses an image display system configured by a computer system. A computer system inputs an image group including a plurality of images of which imaging dates and times, positions, and directions are different, displays a list of the image group on a list screen, and displays a first image selected from the image group on an individual screen based on an operation of a user. In addition, the computer system determines an adjacent image to the first image based on a determination of a spatial positional relationship in a set of the first image and a candidate image that is located in the periphery of the first image in a spatial relationship, and on a determination of an overlap state related to an imaging range, and selects the adjacent image to the first image as a second image based on the operation of the user on the individual screen, and displays the second image as a new first image.

JP2007-093661A discloses a navigation device that is mounted in a vehicle and that simultaneously displays a first map and a second map having an expression form different from the first map. The navigation device comprises a display device, a map display unit, a current position calculation unit, a current position display unit, and a position designation reception unit. The map display unit displays the first map and the second map in different display regions of the display device. The current position calculation unit calculates a current position. The current position display unit displays a current position mark indicating the current position calculated by the current position calculation unit on at least one of the first map or the second map displayed by the map display unit. The position designation reception unit receives a designation of a position on the display region in which the first map is displayed, from a user. The map display unit displays the second map in a form in which a position on the second map indicating the same location as a location on the first map corresponding to the position for which the designation is received by the position designation unit can be identified.

JP2010-200024A discloses a three-dimensional image display device. The three-dimensional image display device comprises a display unit, an instruction input unit, a registration unit, and a display control unit. Before captured images captured from a plurality of viewpoints are displayed in three dimensions, the display unit displays a list of thumbnail images generated from the captured images. The instruction input unit receives a selection instruction to select the thumbnail image in the list. The registration unit performs registration between the captured images of the plurality of viewpoints corresponding to the selected thumbnail image in a detection region of a specific target in the captured image in a case in which the captured image is three-dimensionally displayed in response to an input of the selection instruction. The display control unit adds detection region information indicating the detection region of the specific target to the thumbnail image.

### SUMMARY OF THE INVENTION

One embodiment according to the technology of the present disclosure provides an image processing apparatus, an image processing method, and a program with which a correspondence relationship between each two-dimensional image and a region of a target object corresponding to each two-dimensional image can be understood.

A first aspect according to the technology of the present disclosure relates to an image processing apparatus comprising: a processor, in which the processor is configured to: display, on a screen, a plurality of two-dimensional images that are used to generate a three-dimensional image showing a target object in a real space and that are associated with a plurality of portions of the three-dimensional image, and the three-dimensional image in a state in which the plurality of two-dimensional images and the three-dimensional image are comparable with each other; select a two-dimensional image of interest from among the plurality of two-dimensional images in response to a given selection instruction; and display, on the screen, a portion of interest corresponding to the two-dimensional image of interest among the plurality of portions in a state in which the portion of interest is visually specifiable.

A second aspect according to the technology of the present disclosure relates to the image processing apparatus according to the first aspect, in which the state in which the plurality of two-dimensional images and the three-dimensional image are comparable with each other is a state in which a first region including the plurality of two-dimensional images and a second region including the three-dimensional image are arranged.

A third aspect according to the technology of the present disclosure relates to the image processing apparatus according to the first or second aspect, in which the state in which the portion of interest is visually specifiable includes a state in which the portion of interest is distinguishable from remaining portions among the plurality of portions.

A fourth aspect according to the technology of the present disclosure relates to the image processing apparatus according to any one of the first to third aspects, in which the state in which the portion of interest is visually specifiable includes a state in which the two-dimensional image of interest is distinguishable from remaining two-dimensional images among the plurality of two-dimensional images.

A fifth aspect according to the technology of the present disclosure relates to the image processing apparatus according to any one of the first to fourth aspects, in which the processor is configured to: display, on the screen, a plurality of position specifying images in which a plurality of imaging positions at which imaging for obtaining the plurality of two-dimensional images is performed are specifiable, in a state in which the plurality of position specifying images and the three-dimensional image are comparable with each other; select an imaging position corresponding to a position specifying image of interest, which is selected from among the plurality of position specifying images, as an imaging position of interest from among the plurality of imaging positions in response to the selection instruction; and select a two-dimensional image obtained by performing the imaging from the imaging position of interest as the two-dimensional image of interest from among the plurality of two-dimensional images.

A sixth aspect according to the technology of the present disclosure relates to the image processing apparatus according to the fifth aspect, in which the state in which the plurality of position specifying images and the three-dimensional image are comparable with each other includes a state in which the plurality of position specifying images and the three-dimensional image face each other.

A seventh aspect according to the technology of the present disclosure relates to the image processing apparatus according to the fifth or sixth aspect, in which the state in which the plurality of two-dimensional images and the three-dimensional image are comparable with each other is a state in which a third region including the plurality of two-dimensional images and a fourth region including an image showing an aspect in which the plurality of position specifying images and the three-dimensional image face each other are arranged.

An eighth aspect according to the technology of the present disclosure relates to the image processing apparatus according to any one of the fifth to seventh aspects, in which the state in which the portion of interest is visually specifiable includes a state in which the position specifying image of interest is distinguishable from remaining position specifying images among the plurality of position specifying images.

A ninth aspect according to the technology of the present disclosure relates to the image processing apparatus according to any one of the fifth to eighth aspects, in which the image processing apparatus has a first operation mode in which the plurality of two-dimensional images and the three-dimensional image are displayed on the screen in the state in which the plurality of two-dimensional images and the three-dimensional image are comparable with each other, and a second operation mode in which the plurality of position specifying images are displayed on the screen in the state in which the plurality of position specifying images and the three-dimensional image are comparable with each other, and the processor is configured to set any operation mode of the first operation mode or the second operation mode in response to a given setting instruction.

A tenth aspect according to the technology of the present disclosure relates to the image processing apparatus according to any one of the fifth to ninth aspects, in which the three-dimensional image is displayed on the screen from a viewpoint corresponding to the two-dimensional image of interest.

An eleventh aspect according to the technology of the present disclosure relates to an image processing apparatus comprising: a processor, in which the processor is configured to: display, on a screen, a plurality of two-dimensional images that are used to generate a three-dimensional image showing a target object in a real space and that are associated with a plurality of portions of the three-dimensional image, and the three-dimensional image in a state in which the plurality of two-dimensional images and the three-dimensional image are comparable with each other; select a portion of interest from among the plurality of portions in response to a given selection instruction; select a two-dimensional image of interest corresponding to the portion of interest from among the plurality of two-dimensional images; and display, on the screen, the two-dimensional image of interest in a state in which the two-dimensional image of interest is distinguishable from remaining two-dimensional images among the plurality of two-dimensional images.

A twelfth aspect according to the technology of the present disclosure relates to the image processing apparatus according to the eleventh aspect, in which the processor is configured to: display, on the screen, a plurality of position specifying images in which a plurality of imaging positions at which imaging for obtaining the plurality of two-dimensional images is performed are specifiable, in a state in which the plurality of position specifying images and the three-dimensional image are comparable with each other; select a position specifying image of interest from among the plurality of position specifying images in response to the selection instruction; and select the two-dimensional image obtained by performing the imaging from the imaging position specified from the position specifying image of interest as the two-dimensional image of interest from among the plurality of two-dimensional images.

A thirteenth aspect according to the technology of the present disclosure relates to an image processing method comprising: displaying, on a screen, a plurality of two-dimensional images that are used to generate a three-dimensional image showing a target object in a real space and that are associated with a plurality of portions of the three-dimensional image, and the three-dimensional image in a state in which the plurality of two-dimensional images and the three-dimensional image are comparable with each other; selecting a two-dimensional image of interest from among the plurality of two-dimensional images in response to a given selection instruction; and displaying, on the screen, a portion of interest corresponding to the two-dimensional image of interest among the plurality of portions in a state in which the portion of interest is visually specifiable.

A fourteenth aspect according to the technology of the present disclosure relates to a program for causing a computer to execute a process comprising: displaying, on a screen, a plurality of two-dimensional images that are used to generate a three-dimensional image showing a target object in a real space and that are associated with a plurality of portions of the three-dimensional image, and the three-dimensional image in a state in which the plurality of two-dimensional images and the three-dimensional image are comparable with each other; selecting a two-dimensional image of interest from among the plurality of two-dimensional images in response to a given selection instruction; and displaying, on the screen, a portion of interest corresponding to the two-dimensional image of interest among the plurality of portions in a state in which the portion of interest is visually specifiable.

### BRIEF DESCRIPTION OF THE DRAWINGS

FIG. 1 is a perspective view showing an example of an inspection system according to a first embodiment.

FIG. 2 is a block diagram showing an example of an inspection support apparatus according to the first embodiment.

FIG. 3 is a block diagram showing an example of an imaging apparatus according to the first embodiment.

FIG. 4 is a block diagram showing an example of a functional configuration for implementing inspection support information generation processing according to the first embodiment.

FIG. 5 is a block diagram showing an example of data transmitted from the imaging apparatus according to the first embodiment to the inspection support apparatus.

FIG. 6 is a block diagram showing an example of operations of an acquisition unit and a three-dimensional image generation unit according to the first embodiment.

FIG. 7 is a block diagram showing an example of operations of the three-dimensional image generation unit and an inspection support information generation unit according to the first embodiment.

FIG. 8 is a block diagram showing an example of a functional configuration for implementing inspection support processing according to the first embodiment.

FIG. 9 is a block diagram showing an example of operations of an operation mode setting unit, a first mode processing unit, a second mode processing unit, and a third mode processing unit according to the first embodiment.

FIG. 10 is a block diagram showing an example of an operation of a first display control unit according to the first embodiment.

FIG. 11 is a block diagram showing an example of an operation of a first image selection unit according to the first embodiment.

FIG. 12 is a block diagram showing an example of operations of a first pixel extraction unit and a first image generation unit according to the first embodiment.

FIG. 13 is a block diagram showing an example of the operations of the first image generation unit and the first display control unit according to the first embodiment.

FIG. 14 is a block diagram showing an example of an operation of a second display control unit according to the first embodiment.

FIG. 15 is a block diagram showing an example of an operation of a second image selection unit according to the first embodiment.

FIG. 16 is a block diagram showing an example of operations of a second pixel extraction unit and a second image generation unit according to the first embodiment.

FIG. 17 is a block diagram showing an example of the operations of the second image generation unit and the second display control unit according to the first embodiment.

FIG. 18 is a block diagram showing an example of an operation of a third display control unit according to the first embodiment.

FIG. 19 is a block diagram showing an example of an operation of a third image selection unit according to the first embodiment.

FIG. 20 is a block diagram showing an example of an operation of a third image generation unit according to the first embodiment.

FIG. 21 is a block diagram showing an example of the operations of the third image generation unit and the third display control unit according to the first embodiment.

FIG. 22 is a flowchart showing an example of a flow of the inspection support information generation processing according to the first embodiment.

FIG. 23 is a flowchart showing an example of a flow of mode setting processing in the inspection support processing according to the first embodiment.

FIG. 24 is a flowchart showing an example of a flow of first mode processing in the inspection support processing according to the first embodiment.

FIG. 25 is a flowchart showing an example of a flow of second mode processing in the inspection support processing according to the first embodiment.

FIG. 26 is a flowchart showing an example of a flow of third mode processing in the inspection support processing according to the first embodiment.

FIG. 27 is a block diagram showing an example of an operation of a fourth display control unit according to a second embodiment.

FIG. 28 is a block diagram showing an example of an operation of a fourth image selection unit according to the second embodiment.

FIG. 29 is a block diagram showing an example of operations of a fourth pixel extraction unit and a fourth image generation unit according to the second embodiment.

FIG. 30 is a block diagram showing an example of the operations of the fourth image generation unit and the fourth display control unit according to the second embodiment.

FIG. 31 is a flowchart showing an example of inspection support processing according to the second embodiment.

### DESCRIPTION OF THE PREFERRED EMBODIMENTS

An example of embodiments of an image processing apparatus, an image processing method, and a program according to the technology of the present disclosure will be hereinafter described with reference to the accompanying drawings.

First, the terms used in the following description will be described.

CPU is an abbreviation for “central processing unit”. GPU is an abbreviation for “graphics processing unit”. HDD is an abbreviation for “hard disk drive”. SSD is an abbreviation for “solid-state drive”. RAM is an abbreviation for “random-access memory”. SRAM is an abbreviation for “static random-access memory”. DRAM is an abbreviation for “dynamic random-access memory”. EL is an abbreviation for “electroluminescence”. RAM is an abbreviation for “random-access memory”. CMOS is an abbreviation for “complementary metal-oxide-semiconductor”. GNSS is an abbreviation for “global navigation satellite system”. GPS is an abbreviation for “global positioning system”. SfM is an abbreviation for “structure from motion”. MVS is an abbreviation for “multi-view stereo”. TPU is an abbreviation for “tensor processing unit”. USB is an abbreviation for “Universal Serial Bus”. ASIC is an abbreviation for “application-specific integrated circuit”. FPGA is an abbreviation for “field-programmable gate array”. PLD is an abbreviation for “programmable logic device”. SoC is an abbreviation for “system-on-a-chip”. IC is an abbreviation for “integrated circuit”.

### First Embodiment

First, a first embodiment of the present disclosure will be described.

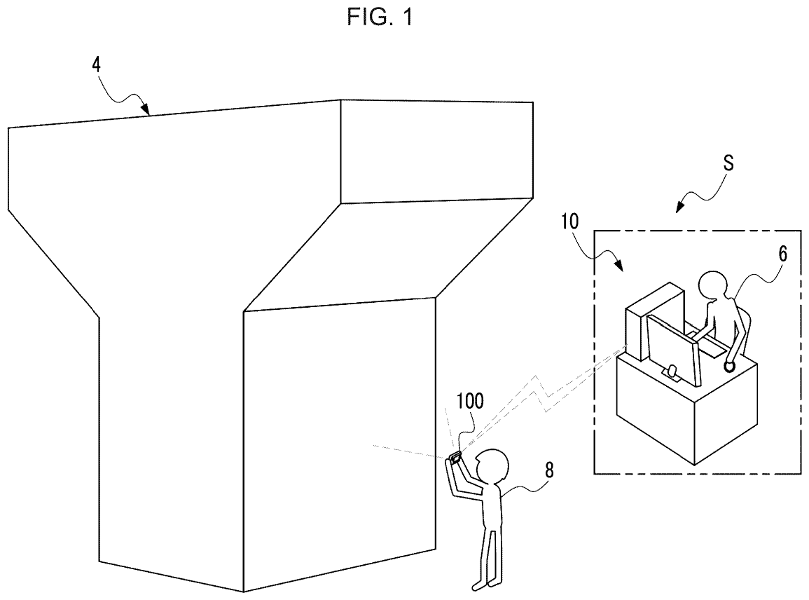

As an example, as shown in FIG. 1, an inspection system S comprises an inspection support apparatus 10 and an imaging apparatus 100. The inspection system S is a system for inspecting a target object 4 in a real space. The target object 4 is an example of a “target object” according to the technology of the present disclosure.

As an example, the target object 4 is a bridge pier made of reinforced concrete. Here, examples of the target object 4 include the bridge pier, but the target object 4 may be a road facility other than the bridge pier. Examples of the road facility include a road surface, a tunnel, a guardrail, a traffic signal, and/or a windbreak fence. The target object 4 may be a social infrastructure (for example, airport facility, port facility, water storage facility, gas facility, medical facility, firefighting facility, and/or educational facility) other than the road facility, or may be a private possession. In addition, the target object 4 may be a land (for example, a public land and/or a private land). The bridge pier shown as the target object 4 may be a bridge pier made of a material other than the reinforced concrete. In the first embodiment, the inspection refers to, for example, an inspection of a state of the target object 4. For example, the inspection system S inspects the presence or absence of damage of the target object 4 and/or a degree of damage.

The inspection support apparatus 10 is an example of an “image processing apparatus” according to the technology of the present disclosure. The inspection support apparatus 10 is, for example, a desktop personal computer. Here, the desktop personal computer is shown as the inspection support apparatus 10, but this is merely an example, and a laptop personal computer may be used. In addition, the inspection support apparatus 10 is not limited to the personal computer and may be a server. The server may be a mainframe used on-premises together with the inspection support apparatus 10, or may be an external server implemented by cloud computing. Further, the server may be an external server implemented by network computing such as fog computing, edge computing, or grid computing. The inspection support apparatus 10 is communicably connected to the imaging apparatus 100. The inspection support apparatus 10 is used by an inspector 6. The inspection support apparatus 10 may be used at a site in which the target object 4 is installed, or may be used at a place different from the site in which the target object 4 is installed.

The imaging apparatus 100 is, for example, a lens-interchangeable digital camera. Here, although a lens-interchangeable digital camera is shown as the imaging apparatus 100, this is merely an example, and a digital camera built into various electronic apparatuses such as a smart device and a wearable terminal may be used. Further, the imaging apparatus 100 may be an eyeglass-type eyewear terminal or a head mount display terminal to be mounted on a head. The imaging apparatus 100 is used by a person in charge of imaging 8.

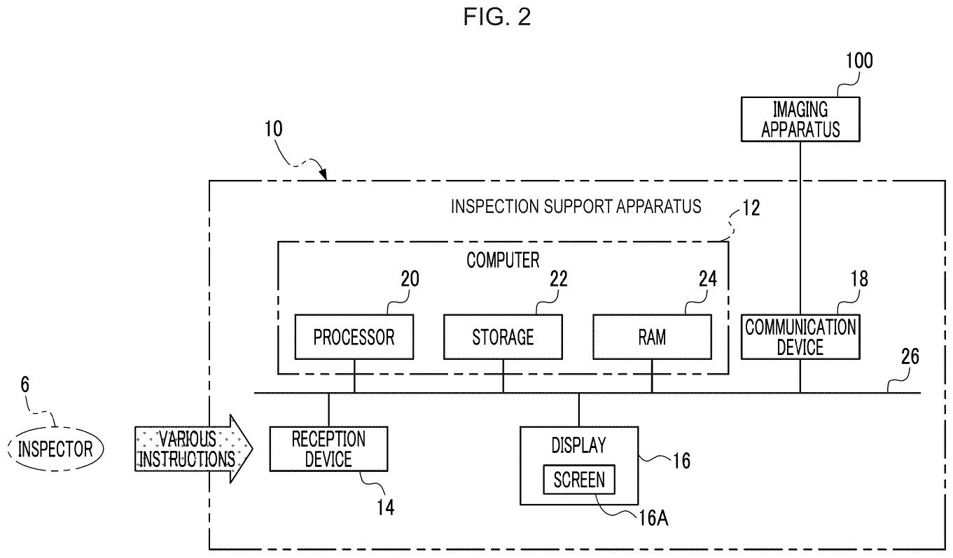

As shown in FIG. 2 as an example, the inspection support apparatus 10 comprises a computer 12, a reception device 14, a display 16, and a communication device 18.

The computer 12 is an example of a “computer” according to the technology of the present disclosure. The computer 12 comprises a processor 20, a storage 22, and a RAM 24. The processor 20 is an example of a “processor” according to the technology of the present disclosure. The processor 20, the storage 22, the RAM 24, the reception device 14, the display 16, and the communication device 18 are connected to a bus 26.

The processor 20 includes, for example, a CPU, and controls the entire inspection support apparatus 10. Here, the example is described in which the processor 20 includes the CPU, but this is merely an example. For example, the processor 20 may include a CPU and a GPU. In this case, for example, the GPU operates under control of the CPU and is responsible for executing image processing.

The storage 22 is a nonvolatile storage device that stores various programs, various parameters, and the like. Examples of the storage 22 include an HDD and an SSD. It should be noted that the HDD and the SSD are merely examples, and a flash memory, a magnetoresistive memory, and/or a ferroelectric memory may be used instead of the HDD and/or the SSD or together with the HDD and/or the SSD.

The RAM 24 is a memory that transitorily stores information, and is used as a work memory by the processor 20. Examples of the RAM 24 include a DRAM and/or an SRAM.

The reception device 14 includes a keyboard, a mouse, a touch panel, and the like (all of which are not shown), and receives various instructions from the inspector 6. The display 16 includes a screen 16A. The screen 16A is an example of a “screen” according to the technology of the present disclosure. The display 16 displays various types of information (for example, an image and text) on the screen 16A under the control of the processor 20. Examples of the display 16 include an EL display (for example, an organic EL display or an inorganic EL display). It should be noted that the display 16 is not limited to the EL display, and another type of display, such as a liquid-crystal display, may be used.

The communication device 18 is communicably connected to the imaging apparatus 100. Here, the communication device 18 is connected to the imaging apparatus 100 in a wirelessly communicable manner through a predetermined wireless communication standard. Examples of the predetermined wireless communication standard include Wi-Fi (registered trademark) and Bluetooth (registered trademark). The communication device 18 controls the exchange of the information between the inspection support apparatus 10. For example, the communication device 18 transmits the information in response to a request from the processor 20 to the imaging apparatus 100. In addition, the communication device 18 receives the information transmitted from the imaging apparatus 100, and outputs the received information to the processor 20 via the bus 26. It should be noted that the communication device 18 may be connected to the imaging apparatus 100 in a communicable manner through a wire.

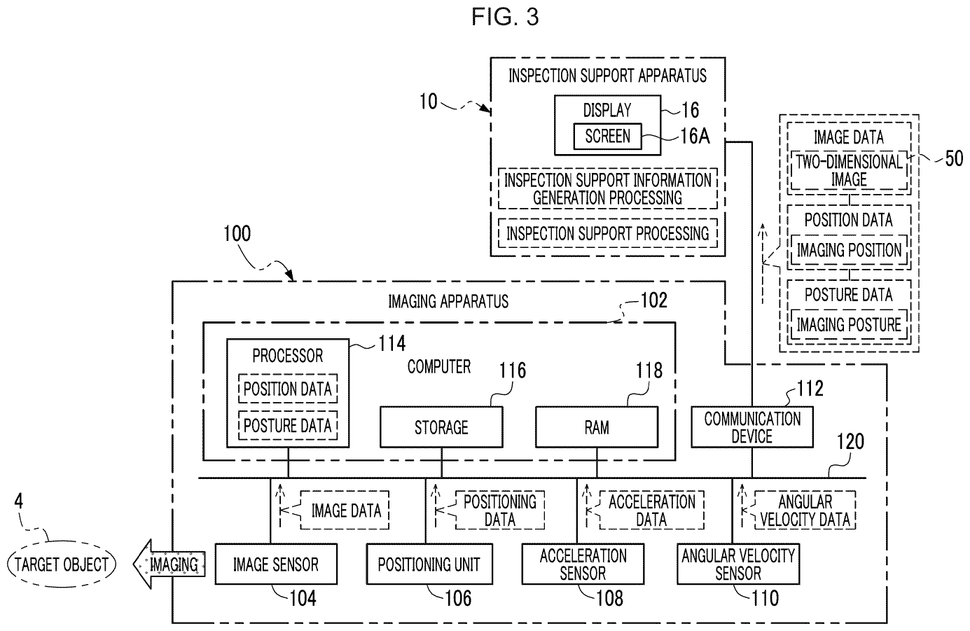

As shown in FIG. 3 as an example, the imaging apparatus 100 comprises a computer 102, an image sensor 104, a positioning unit 106, an acceleration sensor 108, an angular velocity sensor 110, and a communication device 112.

The computer 102 comprises a processor 114, a storage 116, and a RAM 118. The processor 114, the storage 116, the RAM 118, the image sensor 104, the positioning unit 106, the acceleration sensor 108, the angular velocity sensor 110, and the communication device 112 are connected to a bus 120. The processor 114, the storage 116, and the RAM 118 are implemented by, for example, the same hardware as the processor 20, the storage 22, and the RAM 24 provided in the inspection support apparatus 10.

The image sensor 104 is, for example, a CMOS image sensor. It should be noted that, here, the CMOS image sensor is shown as the image sensor 104, but the technology of the present disclosure is not limited to this, and another image sensor may be applied. The image sensor 104 images a subject (for example, the target object 4), and outputs image data obtained by the imaging.

The positioning unit 106 is a device that detects a position of the imaging apparatus 100. The position of the imaging apparatus 100 is detected by using, for example, a global navigation satellite system (GNSS) (for example, a GPS). The positioning unit 106 includes a GNSS receiver (not shown). The GNSS receiver receives, for example, radio waves transmitted from a plurality of satellites. The positioning unit 106 detects the position of the imaging apparatus 100 based on the radio waves received by the GNSS receiver, and outputs positioning data (for example, data indicating the latitude, the longitude, and the altitude) according to the detected position.

The acceleration sensor 108 detects acceleration in axial directions of each of a pitch axis, a yaw axis, and a roll axis of the imaging apparatus 100. The acceleration sensor 108 outputs acceleration data corresponding to the acceleration in each axial direction of the imaging apparatus 100. The angular velocity sensor 110 detects angular velocity around each axis of the pitch axis, the yaw axis, and the roll axis of the imaging apparatus 100. The angular velocity sensor 110 outputs angular velocity data corresponding to the angular velocity around each axis of the imaging apparatus 100.

The processor 114 acquires the position of the imaging apparatus 100 based on the positioning data and/or the acceleration data, and generates position data indicating the acquired position. In addition, the processor 114 acquires a posture of the imaging apparatus 100 (that is, an amount of change in the posture with respect to a reference posture determined in a relative coordinate system) based on the angular velocity data, and generates posture data indicating the acquired posture. Hereinafter, the position of the imaging apparatus 100 will be referred to as an “imaging position”, and the posture of the imaging apparatus 100 will be referred to as an “imaging posture”.

It should be noted that, in a case in which the processor 114 acquires the imaging position based only on the positioning data, the acceleration sensor 108 may be omitted. On the other hand, in a case in which the processor 114 acquires the imaging position based only on the acceleration data, the positioning unit 106 may be omitted. In a case in which the processor 114 acquires the imaging position based on the positioning data, an imaging position in an absolute coordinate system is derived based on the positioning data. On the other hand, in a case in which the processor 114 acquires the imaging position based on the acceleration data, the amount of change in the imaging position with respect to the reference position determined in the relative coordinate system is derived based on the acceleration data.

The communication device 112 is communicably connected to the inspection support apparatus 10. The communication device 112 is implemented by using, for example, the same hardware as the communication device 18 provided in the inspection support apparatus 10.

The imaging apparatus 100 transmits the image data, the position data, and the posture data to the inspection support apparatus 10. The image data is data indicating a two-dimensional image 50 obtained by imaging the target object 4 via the imaging apparatus 100. The position data is data indicating the imaging position in a case in which the imaging apparatus 100 performs the imaging, and is associated with the image data. Similarly, the posture data is data indicating the imaging posture in a case in which the imaging apparatus 100 performs the imaging, and is associated with the image data. That is, the position data and the posture data are accessory data incidental to the image data.

Meanwhile, for example, in a case in which only a plurality of two-dimensional images 50 obtained by imaging the target object 4 from a plurality of imaging positions via the imaging apparatus 100 are displayed on the screen 16A of the display 16 provided in the inspection support apparatus 10, it takes time and effort to understand a correspondence relationship between each two-dimensional image 50 and a region in the target object 4 corresponding to each two-dimensional image 50 based on the plurality of two-dimensional images 50 displayed on the screen 16A. In addition, as the number of frames of the plurality of two-dimensional images 50 is increased, the complexity of the work of understanding the correspondence relationship is increased. In view of such circumstances, in the first embodiment, the inspection support apparatus 10 performs inspection support information generation processing and inspection support processing. Hereinafter, details of the inspection support information generation processing and the inspection support processing performed by the inspection support apparatus 10 will be described.

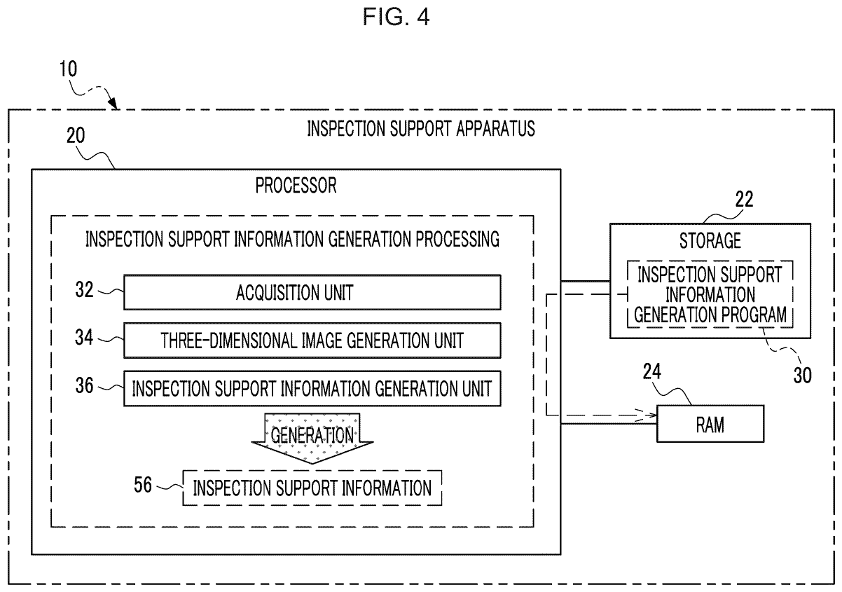

As shown in FIG. 4 as an example, the storage 22 of the inspection support apparatus 10 stores an inspection support information generation program 30. The processor 20 of the inspection support apparatus 10 reads out the inspection support information generation program 30 from the storage 22, and executes the readout inspection support information generation program 30 on the RAM 24. The processor 20 performs the inspection support information generation processing for generating inspection support information 56 according to the inspection support information generation program 30 executed on the RAM 24.

The inspection support information generation processing is implemented by the processor 20 operating as an acquisition unit 32, a three-dimensional image generation unit 34, and an inspection support information generation unit 36 according to the inspection support information generation program 30.

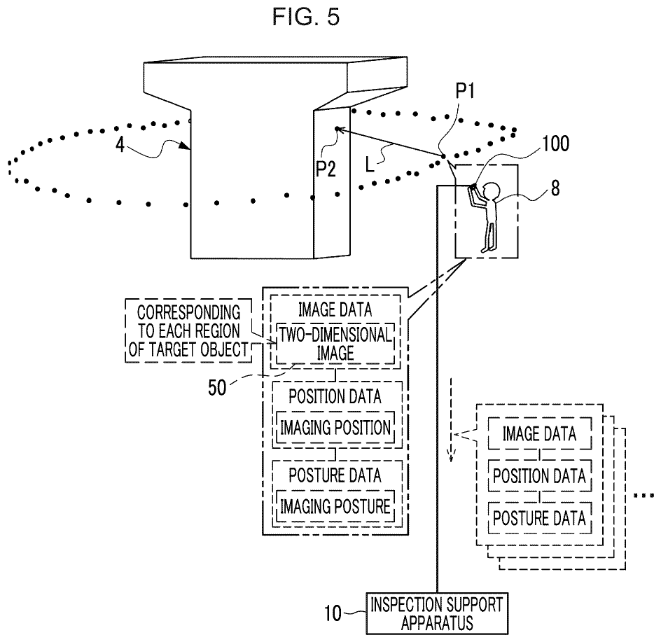

As an example, as shown in FIG. 5, a plurality of points P1 located in a circumferential direction of the target object 4 indicate the imaging positions of the imaging apparatus 100. The person in charge of imaging 8 images the target object 4 via the imaging apparatus 100 from the plurality of imaging positions in the circumferential direction of the target object 4 while moving around the periphery of the target object 4. As an example, the person in charge of imaging 8 images different regions in the target object 4 from each imaging position via the imaging apparatus 100. By imaging different regions in the target object 4 from each imaging position via the imaging apparatus 100, the entire target object 4 including a plurality of regions is imaged.

The imaging position (that is, the point P1) corresponding to each two-dimensional image 50 obtained by being captured by the imaging apparatus 100 corresponds to a starting point of a visual line L focused on the target object 4, and the imaging posture corresponding to each two-dimensional image 50 corresponds to a direction of the visual line L focused on the target object 4. A point P2 at which the target object 4 and the visual line L intersect each other corresponds to a viewpoint in a case in which the target object 4 is viewed along the visual line L. The target object 4 is imaged by the imaging apparatus 100 from each imaging position, whereby the two-dimensional image 50 corresponding to each viewpoint is obtained. Each two-dimensional image 50 is an image corresponding to each region of the target object 4.

It should be noted that, here, although the example is shown in which the person in charge of imaging 8 images the target object 4 via the imaging apparatus 100 from each imaging position while moving around the periphery of the target object 4, the target object 4 may be imaged by the imaging apparatus 100 from each imaging position in a case in which the imaging apparatus 100 is mounted in a mobile object and the mobile object moves around the periphery of the target object 4. In addition, the mobile object may be, for example, a drone, a gondola, a truck, a high-altitude work vehicle, an automatic guided vehicle, or another vehicle.

The imaging apparatus 100 associates the image data indicating the two-dimensional image 50 obtained by being captured from each imaging position with the position data indicating the imaging position in a case in which the imaging is performed, and the posture data indicating the imaging posture in a case in which the imaging is performed. Then, the imaging apparatus 100 transmits each image data, and the position data and the posture data which are associated with each image data to the inspection support apparatus 10.

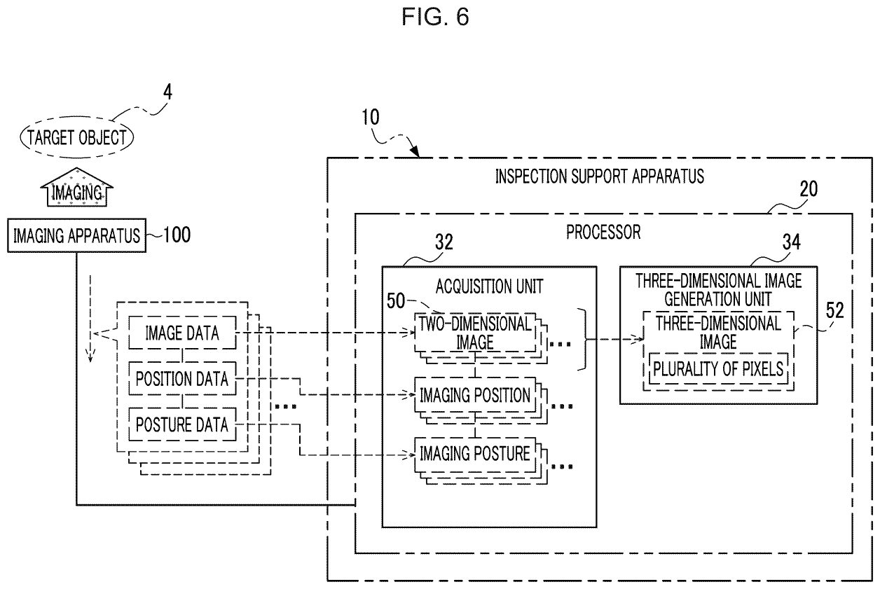

As shown in FIG. 6 as an example, the acquisition unit 32 acquires the two-dimensional image 50 based on each image data received by the inspection support apparatus 10. In addition, the acquisition unit 32 acquires the imaging position corresponding to each two-dimensional image 50 based on each position data received by the inspection support apparatus 10. Further, the acquisition unit 32 acquires the imaging posture corresponding to each two-dimensional image 50 based on each posture data received by the inspection support apparatus 10.

The three-dimensional image generation unit 34 generates a three-dimensional image 52 showing the target object 4 based on the plurality of two-dimensional images 50 acquired by the acquisition unit 32. Examples of the image processing technique of generating the three-dimensional image 52 based on the plurality of two-dimensional images 50 include SfM, MVS, Epipolar geometry, and stereo matching processing. The positions of a plurality of pixels included in the three-dimensional image 52 are specified by a plurality of three-dimensional coordinates obtained from the plurality of two-dimensional images 50. The three-dimensional image 52 is a three-dimensional model defined by the plurality of three-dimensional coordinates.

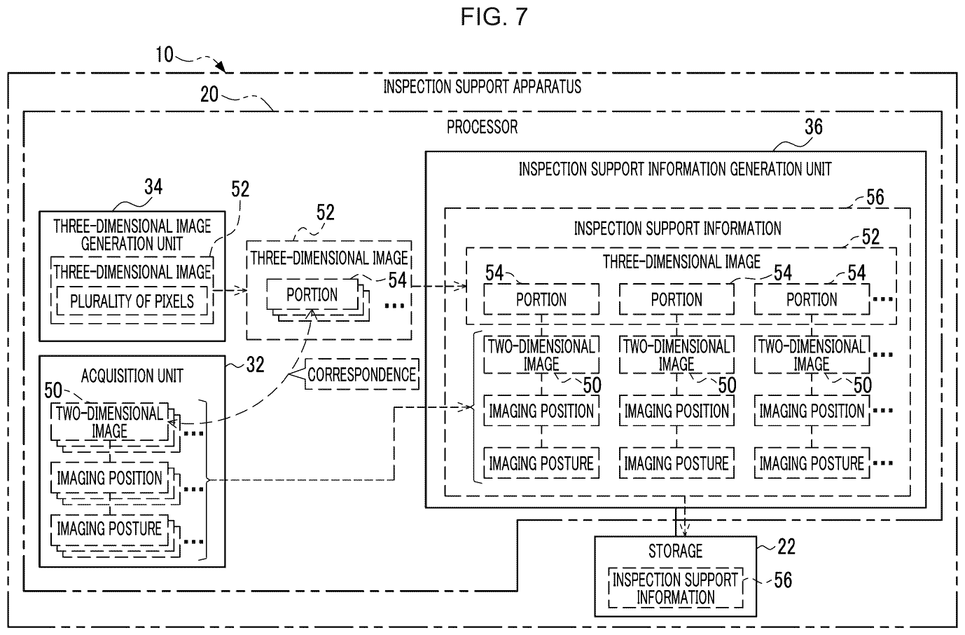

As shown in FIG. 7 as an example, the three-dimensional image 52 generated by the three-dimensional image generation unit 34 has a plurality of portions 54 corresponding to each two-dimensional image 50. Each portion 54 is formed of a pixel group which is a set of pixels corresponding to each two-dimensional image 50. The inspection support information generation unit 36 generates the inspection support information 56 that is information in which each two-dimensional image 50 acquired by the acquisition unit 32, the imaging position corresponding to each two-dimensional image 50, the imaging posture corresponding to each two-dimensional image 50, and the portion 54 corresponding to each two-dimensional image 50 are associated with each other. The inspection support information 56 is stored in the storage 22.

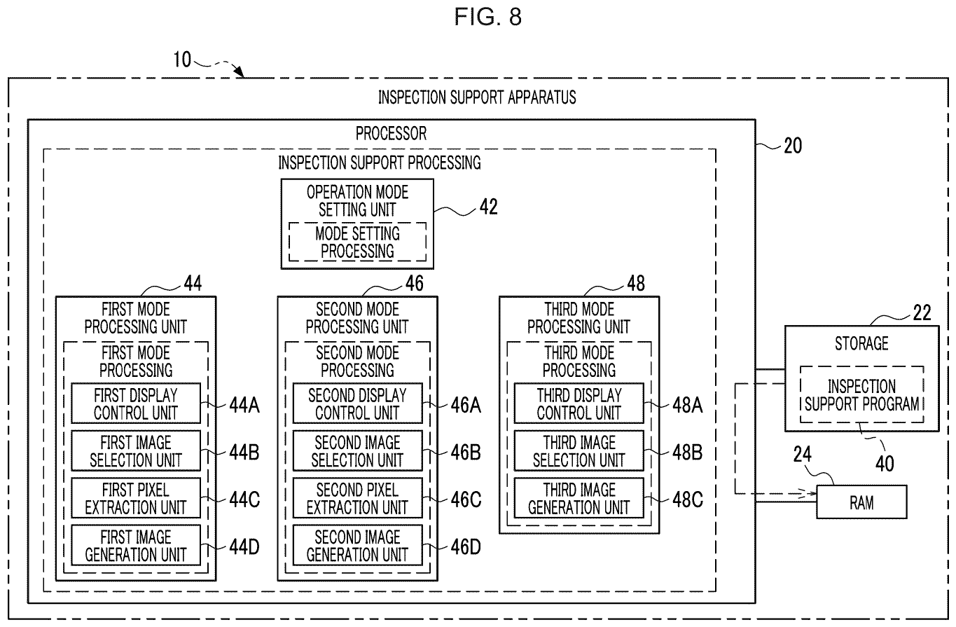

As an example, as shown in FIG. 8, the storage 22 of the inspection support apparatus 10 stores an inspection support program 40. The inspection support program 40 is an example of a “program” according to the technology of the present disclosure. The processor 20 reads out the inspection support program 40 from the storage 22, and executes the readout inspection support program 40 on the RAM 24. The processor 20 performs the inspection support processing for supporting the inspection performed by the inspector 6 (see FIG. 1) according to the inspection support program 40 executed on the RAM 24.

The inspection support processing is implemented by the processor 20 operating as an operation mode setting unit 42, a first mode processing unit 44, a second mode processing unit 46, and a third mode processing unit 48 according to the inspection support program 40.

The inspection support apparatus 10 has a first mode, a second mode, and a third mode as operation modes. The operation mode setting unit 42 performs mode setting processing for selectively setting the first mode, the second mode, and the third mode as the operation mode of the inspection support apparatus 10.

In the mode setting processing, in a case in which the operation mode of the inspection support apparatus 10 is set to the first mode by the operation mode setting unit 42, the processor 20 operates as the first mode processing unit 44. The first mode processing unit 44 performs first mode processing. The first mode processing is implemented by the first mode processing unit 44 operating as a first display control unit 44A, a first image selection unit 44B, a first pixel extraction unit 44C, and a first image generation unit 44D.

In the mode setting processing, in a case in which the operation mode of the inspection support apparatus 10 is set to the second mode by the operation mode setting unit 42, the processor 20 operates as the second mode processing unit 46. The second mode processing unit 46 performs second mode processing. The second mode processing is implemented by the second mode processing unit 46 operating as a second display control unit 46A, a second image selection unit 46B, a second pixel extraction unit 46C, and a second image generation unit 46D.

In the mode setting processing, in a case in which the operation mode of the inspection support apparatus 10 is set to the third mode by the operation mode setting unit 42, the processor 20 operates as the third mode processing unit 48. The third mode processing unit 48 performs third mode processing. The third mode processing is implemented by the third mode processing unit 48 operating as a third display control unit 48A, a third image selection unit 48B, and a third image generation unit 48C.

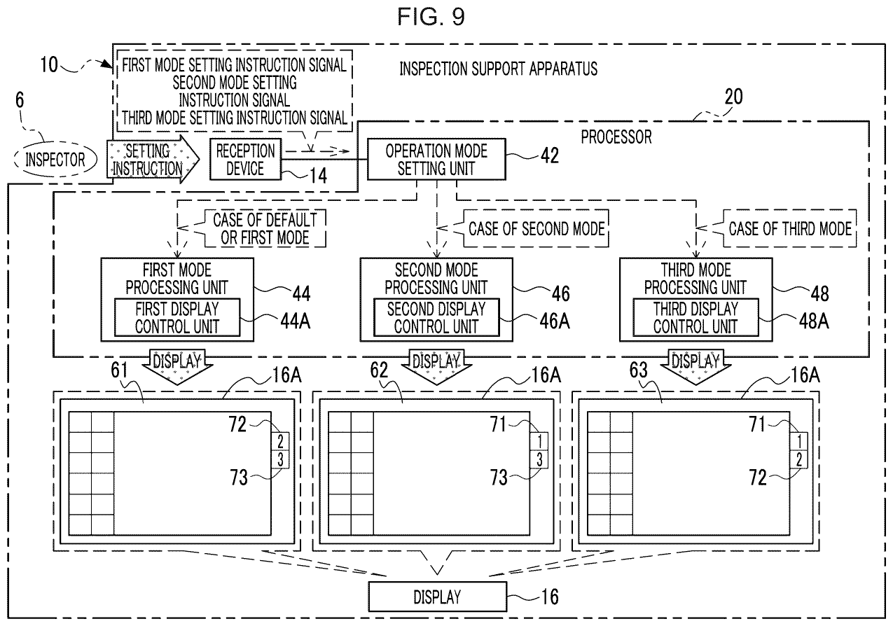

As shown in FIG. 9 as an example, the operation mode setting unit 42 sets the first mode as the operation mode of the inspection support apparatus 10 by default. In a case in which the operation mode of the inspection support apparatus 10 is set to the first mode by the operation mode setting unit 42, the first display control unit 44A displays a first image 61 on the screen 16A. Details of the first image 61 will be described later, but the first image 61 includes a second mode setting button 72 and a third mode setting button 73 as soft keys.

In a case in which a setting instruction, which is an instruction to press the second mode setting button 72, is received by the reception device 14 in a state in which the first image 61 is displayed on the screen 16A, the reception device 14 outputs a second mode setting instruction signal to the processor 20. Similarly, in a case in which a setting instruction, which is an instruction to press the third mode setting button 73, is received by the reception device 14 in a state in which the first image 61 is displayed on the screen 16A, the reception device 14 outputs a third mode setting instruction signal to the processor 20.

The operation mode setting unit 42 determines whether the second mode setting instruction signal or the third mode setting instruction signal is input to the processor 20 in a case in which the operation mode of the inspection support apparatus 10 is set to the first mode. In a case in which the second mode setting instruction signal is input to the processor 20, the operation mode setting unit 42 sets the second mode as the operation mode of the inspection support apparatus 10. On the other hand, in a case in which the third mode setting instruction signal is input to the processor 20, the operation mode setting unit 42 sets the third mode as the operation mode of the inspection support apparatus 10.

In a case in which the operation mode of the inspection support apparatus 10 is set to the second mode by the operation mode setting unit 42, the second display control unit 46A displays a second image 62 on the screen 16A. Details of the second image 62 will be described later, but the second image 62 includes a first mode setting button 71 and the third mode setting button 73 as the soft keys.

In a case in which a setting instruction, which is an instruction to press the first mode setting button 71, is received by the reception device 14 in a state in which the second image 62 is displayed on the screen 16A, the reception device 14 outputs a first mode setting instruction signal to the processor 20. Similarly, in a case in which the setting instruction, which is the instruction to press the third mode setting button 73, is received by the reception device 14 in a state in which the second image 62 is displayed on the screen 16A, the reception device 14 outputs the third mode setting instruction signal to the processor 20.

The operation mode setting unit 42 determines whether the first mode setting instruction signal or the third mode setting instruction signal is input to the processor 20 in a case in which the operation mode of the inspection support apparatus 10 is set to the second mode. In a case in which the first mode setting instruction signal is input to the processor 20, the operation mode setting unit 42 sets the first mode as the operation mode of the inspection support apparatus 10. On the other hand, in a case in which the third mode setting instruction signal is input to the processor 20, the operation mode setting unit 42 sets the third mode as the operation mode of the inspection support apparatus 10.

In a case in which the operation mode of the inspection support apparatus 10 is set to the third mode by the operation mode setting unit 42, the third display control unit 48A displays a third image 63 on the screen 16A. Details of the third image 63 will be described later, but the third image 63 includes the first mode setting button 71 and the second mode setting button 72.

In a case in which the setting instruction, which is the instruction to press the first mode setting button 71, is received by the reception device 14 in a state in which the third image 63 is displayed on the screen 16A, the reception device 14 outputs the first mode setting instruction signal to the processor 20. Similarly, in a case in which the setting instruction, which is the instruction to press the third mode setting button 73, is received by the reception device 14 in a state in which the third image 63 is displayed on the screen 16A, the reception device 14 outputs the third mode setting instruction signal to the processor 20.

The operation mode setting unit 42 determines whether the first mode setting instruction signal or the second mode setting instruction signal is input to the processor 20 in a case in which the operation mode of the inspection support apparatus 10 is set to the third mode. In a case in which the first mode setting instruction signal is input to the processor 20, the operation mode setting unit 42 sets the first mode as the operation mode of the inspection support apparatus 10. On the other hand, in a case in which the second mode setting instruction signal is input to the processor 20, the operation mode setting unit 42 sets the second mode as the operation mode of the inspection support apparatus 10.

Hereinafter, in a case in which it is not necessary to distinguish between the first mode setting instruction signal, the second mode setting instruction signal, and the third mode setting instruction signal, the first mode setting instruction signal, the second mode setting instruction signal, and the third mode setting instruction signal are referred to as a “mode setting instruction signal”.

The second mode among a plurality of operation modes of the inspection support apparatus 10 is an example of a “first operation mode” according to the technology of the present disclosure. The third mode among the plurality of operation modes of the inspection support apparatus 10 is an example of a “second operation mode” according to the technology of the present disclosure.

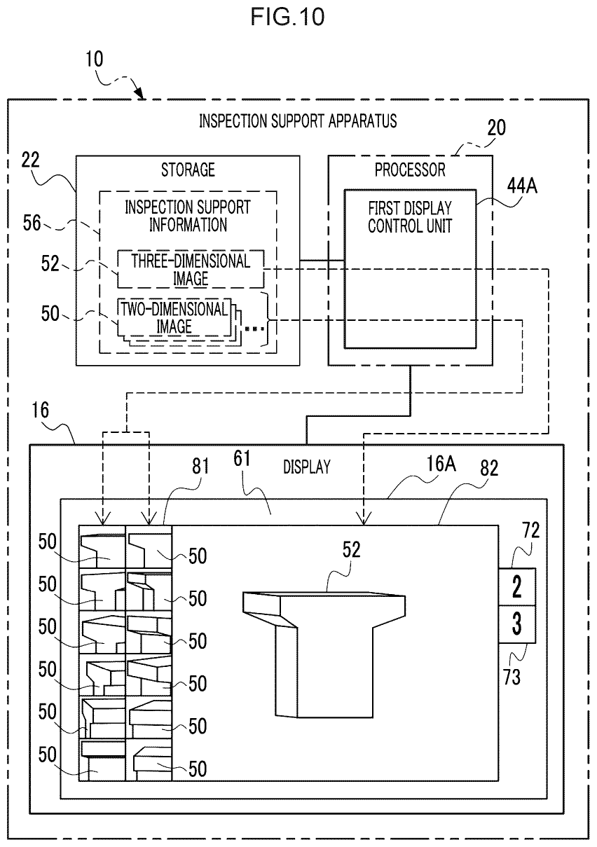

As an example, FIG. 10 shows a state in which the first image 61 is displayed on the screen 16A. The first image 61 includes a first image region 81 and a second image region 82. As an example, the first image region 81 and the second image region 82 are displayed on the screen 16A in a state of being arranged in a left-right direction of the first image 61. The first image region 81 includes the plurality of two-dimensional images 50, and the second image region 82 includes the three-dimensional image 52.

The first display control unit 44A includes the plurality of two-dimensional images 50 in the first image region 81 based on the plurality of two-dimensional images 50 included in the inspection support information 56. Further, the first display control unit 44A includes the three-dimensional image 52 in the second image region 82 based on the three-dimensional image 52 included in the inspection support information 56.

A predetermined number of two-dimensional images 50 among the plurality of two-dimensional images 50 are included in the first image region 81. The predetermined number is set, for example, by the inspector 6 giving an instruction to designate the predetermined number to the reception device 14 (see FIG. 9). In addition, for example, the first image region 81 is scrolled by the inspector 6 giving an instruction to scroll the first image region 81 to the reception device 14, whereby the two-dimensional image 50 included in the first image region 81 is changed.

The three-dimensional image 52 is included in the second image region 82 in a state of being two-dimensionally imaged by rendering. For example, a size of the three-dimensional image 52 is changed by the inspector 6 giving an instruction to change the size of the three-dimensional image 52 to the reception device 14 (see FIG. 9). For example, the three-dimensional image 52 is rotated by the inspector 6 giving an instruction to rotate the three-dimensional image 52 to the reception device 14.

The first image region 81 including the plurality of two-dimensional images 50 and the second image region 82 including the three-dimensional image 52 are displayed on the screen 16A in a state of being arranged, so that the plurality of two-dimensional images 50 and the three-dimensional image 52 are in a state of being comparable with each other. It should be noted that, in the example shown in FIG. 10, the example is shown in which the first image region 81 and the second image region 82 are displayed on the screen 16A in a state of being arranged in the left-right direction of the first image 61. However, for example, the first image region 81 and the second image region 82 may be displayed on the screen 16A in a state of being arranged in an up-down direction of the first image 61, or the first image region 81 and the second image region 82 may be displayed on the screen 16A in a state in which the first image region 81 is incorporated into a part of the second image region 82.

The two-dimensional image 50 is an example of a “two-dimensional image” according to the technology of the present disclosure. The three-dimensional image 52 is an example of a “three-dimensional image” according to the technology of the present disclosure. The first image region 81 is an example of a “first region” according to the technology of the present disclosure. The second image region 82 is an example of a “second region” according to the technology of the present disclosure.

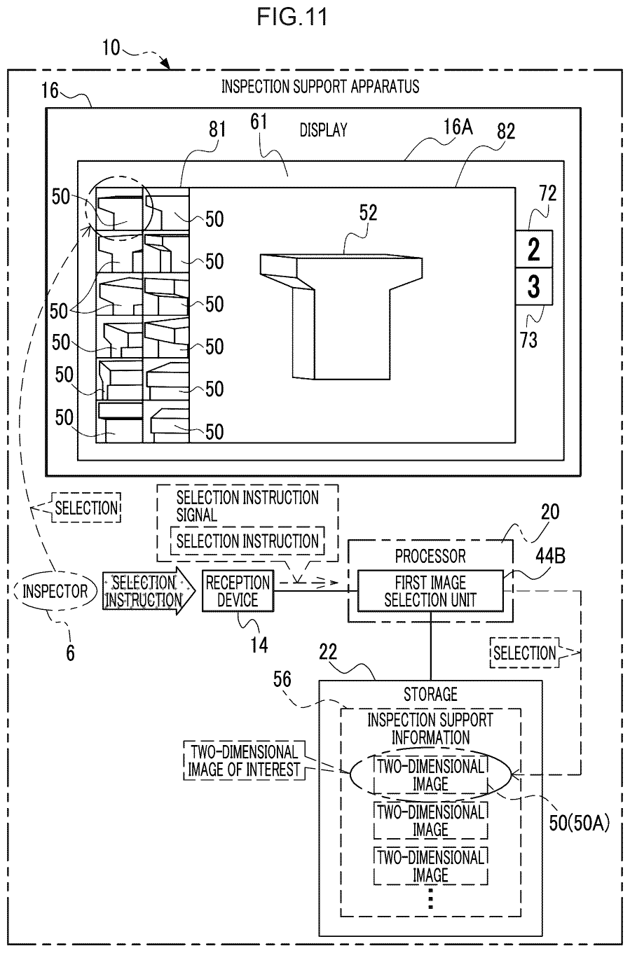

As shown in FIG. 11 as an example, in a case in which a selection instruction, which is an instruction to select any two-dimensional image 50 among the plurality of two-dimensional images 50 included in the first image region 81, is received by the reception device 14 in a state in which the first image 61 is displayed on the screen 16A, the reception device 14 outputs a selection instruction signal indicating the selection instruction to the processor 20. The selection instruction is an example of a “selection instruction” according to the technology of the present disclosure.

In a case in which the selection instruction signal is input to the processor 20, the first image selection unit 44B selects the two-dimensional image 50 (hereinafter, referred to as a “two-dimensional image of interest 50A”) corresponding to the selection instruction from among the plurality of two-dimensional images 50 included in the inspection support information 56 in response to the selection instruction indicated by the selection instruction signal. The two-dimensional image of interest 50A is an example of a “two-dimensional image of interest” according to the technology of the present disclosure.

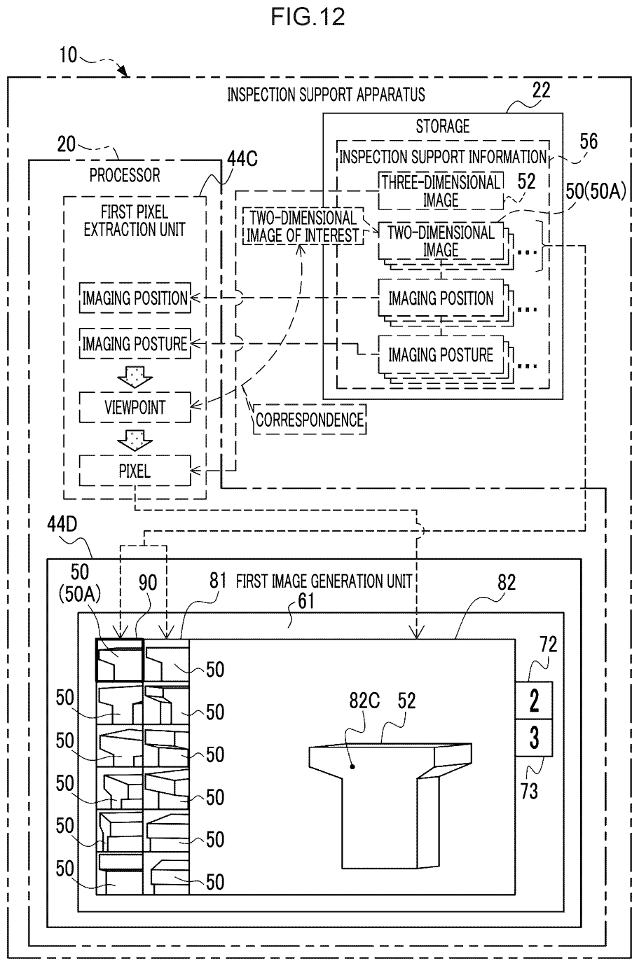

As shown in FIG. 12 as an example, the first pixel extraction unit 44C acquires the imaging position and the imaging posture that correspond to the two-dimensional image of interest 50A from the inspection support information 56. Further, the first pixel extraction unit 44C derives the viewpoint corresponding to the two-dimensional image of interest 50A based on the acquired imaging position and imaging posture. Then, the first pixel extraction unit 44C extracts the pixel for including the three-dimensional image 52 in the second image region 82 at the derived viewpoint from the three-dimensional image 52 included in the inspection support information 56. Further, in a case in which the first pixel extraction unit 44C extracts the pixel from the three-dimensional image 52, the first pixel extraction unit 44C extracts the pixel for including the entire three-dimensional image 52 in a size that is included in the second image region 82, from the three-dimensional image 52.

The first image generation unit 44D includes the predetermined number of two-dimensional images 50 among the plurality of two-dimensional images 50 included in the inspection support information 56, and generates the first image region 81 in an aspect in which the two-dimensional image of interest 50A is surrounded by a frame 90. In addition, the first image generation unit 44D generates the second image region 82 including the three-dimensional image 52 having the size in which the entire three-dimensional image 52 is included in the second image region 82, at the viewpoint corresponding to the two-dimensional image of interest 50A based on the pixel extracted by the first pixel extraction unit 44C. For example, the three-dimensional image 52 is included in the second image region 82 such that the viewpoint corresponding to the two-dimensional image of interest 50A is located at a center 82C of the second image region 82.

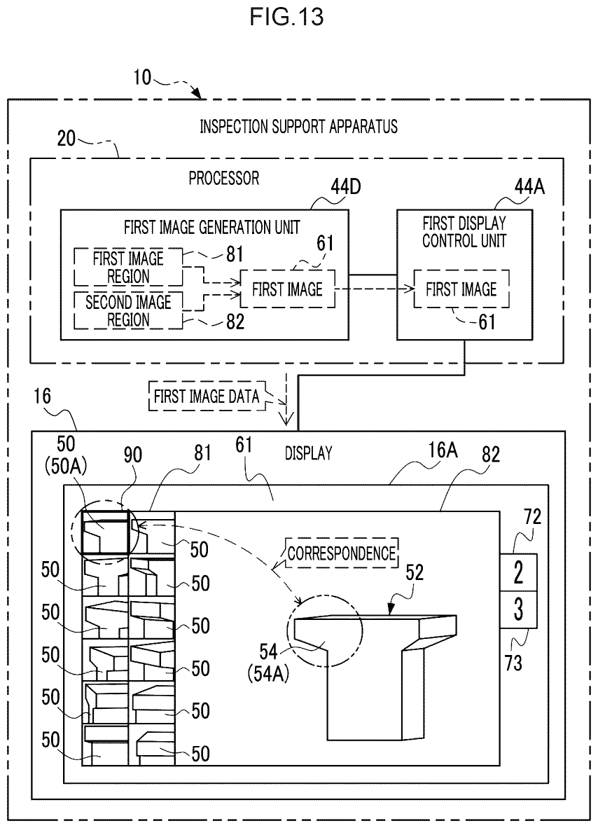

As shown in FIG. 13 as an example, the first image generation unit 44D generates the first image 61 by combining the first image region 81 and the second image region 82 which are generated.

The first display control unit 44A outputs first image data indicating the first image 61 generated by the first image generation unit 44D to the display 16. Consequently, the first image 61 is displayed on the screen 16A of the display 16. Specifically, the predetermined number of two-dimensional images 50 among the plurality of two-dimensional images 50 are displayed on the screen 16A in a state of being included in the first image region 81, and the two-dimensional image of interest 50A is displayed on the screen 16A in a state of being surrounded by the frame 90. The two-dimensional image of interest 50A is displayed on the screen 16A in a state of being surrounded by the frame 90, so that the two-dimensional image of interest 50A is in a state of being distinguishable from the remaining two-dimensional images 50 among the plurality of two-dimensional images 50.

In addition, the three-dimensional image 52 is displayed on the screen 16A in a size in which the entire three-dimensional image 52 is included in the second image region 82, at the viewpoint corresponding to the two-dimensional image of interest 50A. The three-dimensional image 52 is displayed on the screen 16A at the viewpoint corresponding to the two-dimensional image of interest 50A, so that the portion 54 (hereinafter, referred to as a “portion of interest 54A”) in the three-dimensional image 52 corresponding to the two-dimensional image of interest 50A is in a state of being visually specifiable. The “portion 54” is an example of a “portion” according to the technology of the present disclosure, and the portion of interest 54A in the three-dimensional image 52 is an example of a “portion of interest” according to the technology of the present disclosure.

It should be noted that, in the example shown in FIG. 13, the two-dimensional image of interest 50A is displayed on the screen 16A in a state of being surrounded by the frame 90. However, the two-dimensional image of interest 50A may be displayed on the screen 16A in a state of being distinguishable from the remaining two-dimensional images 50 according to another aspect. For example, the two-dimensional image of interest 50A may be displayed on the screen 16A in an aspect in which the two-dimensional image of interest 50A is represented by a different color from the remaining two-dimensional images 50, an aspect in which a pattern is added to the two-dimensional image of interest 50A, or an aspect in which the two-dimensional image of interest 50A has higher brightness than the remaining two-dimensional images 50. Even in such an example, the two-dimensional image of interest 50A is in a state of being distinguishable from the remaining two-dimensional images 50.

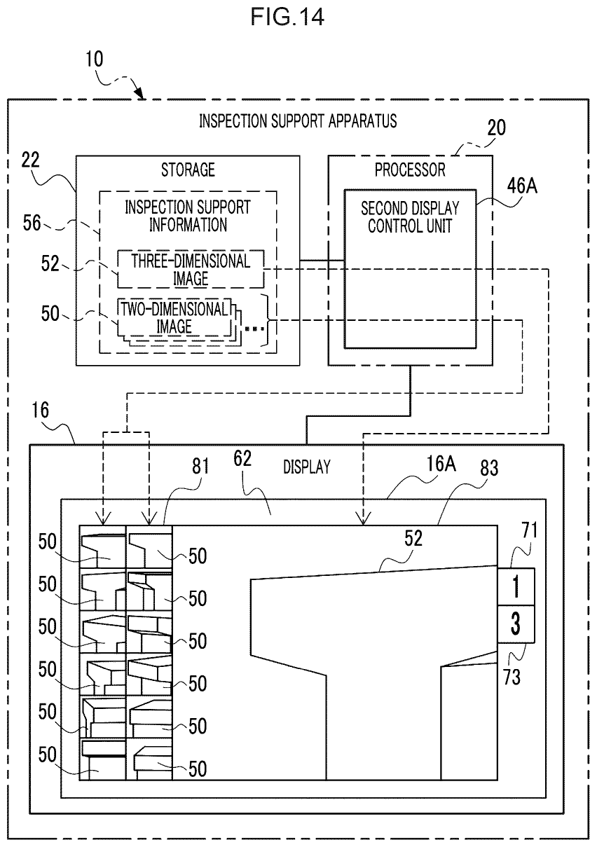

As an example, FIG. 14 shows a state in which the second image 62 is displayed on the screen 16A. The second image 62 includes the first image region 81 and a third image region 83. As an example, the first image region 81 and the third image region 83 are displayed on the screen 16A in a state of being arranged in a left-right direction of the second image 62. The first image region 81 is the same as the first image region 81 of the first image 61 (see FIG. 10). The third image region 83 includes the three-dimensional image 52. The third image region 83 is an example of a “second region” according to the technology of the present disclosure.

The second display control unit 46A includes the plurality of two-dimensional images 50 in the first image region 81 based on the plurality of two-dimensional images 50 included in the inspection support information 56. Further, the second display control unit 46A includes the three-dimensional image 52 in the third image region 83 based on the three-dimensional image 52 included in the inspection support information 56.

The three-dimensional image 52 is included in the third image region 83 in a state of being two-dimensionally imaged by rendering. For example, the size of the three-dimensional image 52 is changed by the inspector 6 giving the instruction to change the size of the three-dimensional image 52 to the reception device 14 (see FIG. 9). For example, the three-dimensional image 52 is rotated by the inspector 6 giving the instruction to rotate the three-dimensional image 52 to the reception device 14.

The first image region 81 including the plurality of two-dimensional images 50 and the third image region 83 including the three-dimensional image 52 are displayed on the screen 16A in a state of being arranged, so that the plurality of two-dimensional images 50 and the three-dimensional image 52 are in a state of being comparable with each other.

It should be noted that, in the example shown in FIG. 14, the example is shown in which the first image region 81 and the third image region 83 are displayed on the screen 16A in a state of being arranged in the left-right direction of the second image 62. However, for example, the first image region 81 and the third image region 83 may be displayed on the screen 16A in a state of being arranged in an up-down direction of the second image 62, or the first image region 81 and the third image region 83 may be displayed on the screen 16A in a state in which the first image region 81 is incorporated into a part of the third image region 83.

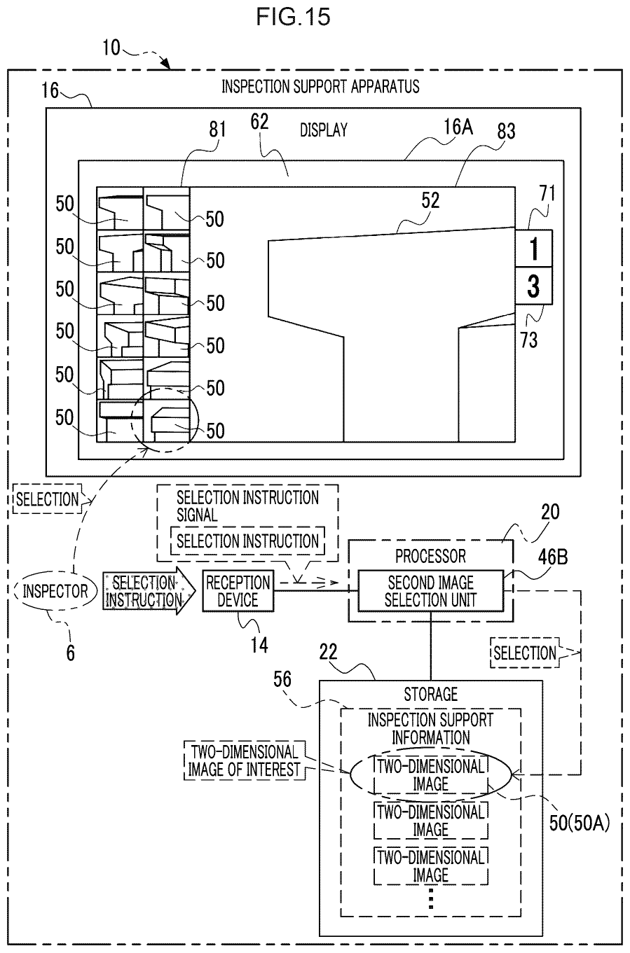

As shown in FIG. 15 as an example, in a case in which the selection instruction, which is the instruction to select any two-dimensional image 50 among the plurality of two-dimensional images 50 included in the first image region 81, is received by the reception device 14 in a state in which the second image 62 is displayed on the screen 16A, the reception device 14 outputs the selection instruction signal indicating the selection instruction to the processor 20.

In a case in which the selection instruction signal is input to the processor 20, the second image selection unit 46B selects the two-dimensional image of interest 50A corresponding to the selection instruction from among the plurality of two-dimensional images 50 included in the inspection support information 56 in response to the selection instruction indicated by the selection instruction signal.

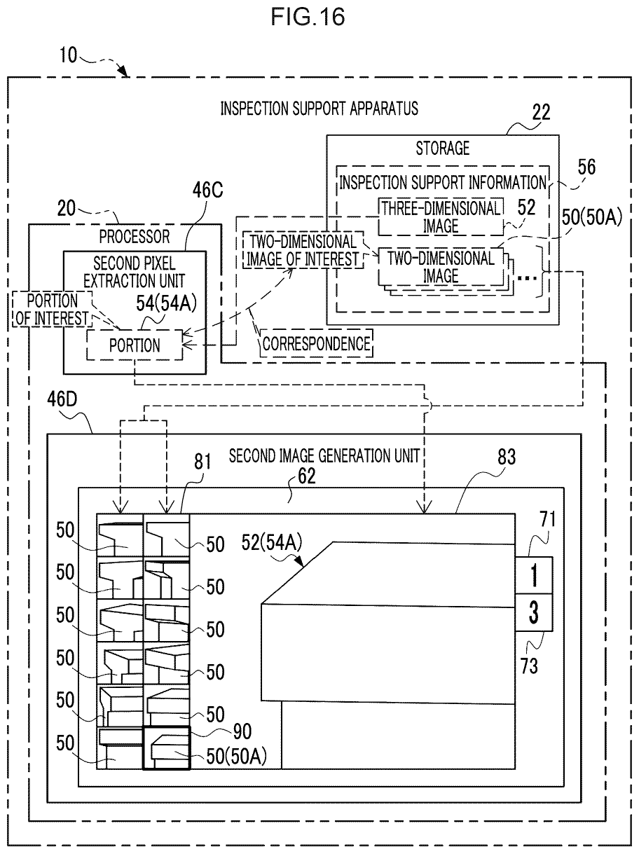

As shown in FIG. 16 as an example, the second pixel extraction unit 46C extracts the portion of interest 54A associated with the two-dimensional image of interest 50A from the three-dimensional image 52 included in the inspection support information 56.

The second image generation unit 46D includes the predetermined number of two-dimensional images 50 among the plurality of two-dimensional images 50 included in the inspection support information 56, and generates the first image region 81 in an aspect in which the two-dimensional image of interest 50A is surrounded by the frame 90. Further, the second image generation unit 46D generates the third image region 83 including the portion of interest 54A in the three-dimensional image 52 based on the portion of interest 54A extracted by the second pixel extraction unit 46C.

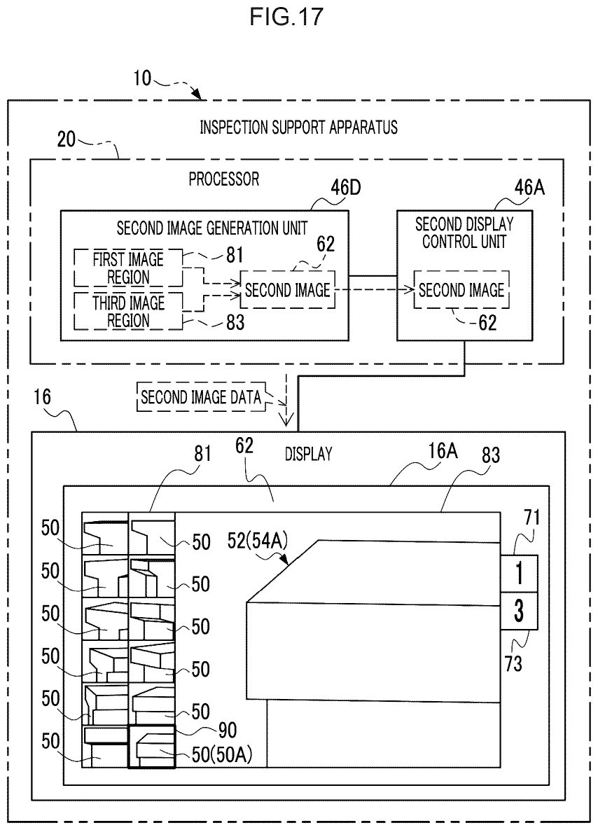

As shown in FIG. 17 as an example, the second image generation unit 46D generates the second image 62 by combining the first image region 81 and the third image region 83 which are generated.

The second display control unit 46A outputs second image data indicating the second image 62 generated by the second image generation unit 46D to the display 16. Consequently, the second image 62 is displayed on the screen 16A of the display 16. Specifically, the predetermined number of two-dimensional images 50 among the plurality of two-dimensional images 50 are displayed on the screen 16A in a state of being included in the first image region 81, and the two-dimensional image of interest 50A is displayed on the screen 16A in a state of being surrounded by the frame 90.

In addition, the portion of interest 54A in the three-dimensional image 52 is displayed on the screen 16A in an enlarged state. The portion of interest 54A in the three-dimensional image 52 is displayed on the screen 16A in an enlarged state, so that the portion of interest 54A in the three-dimensional image 52 is in a state of being visually specifiable. That is, the portion of interest 54A in the three-dimensional image 52 is displayed on the screen 16A in an enlarged state, so that the portion of interest 54A is in a state of being distinguishable from the remaining portions 54 among the plurality of portions 54 forming the three-dimensional image 52. Consequently, the portion of interest 54A in the three-dimensional image 52 is in a state of being visually specifiable.

In addition, the two-dimensional image of interest 50A is displayed on the screen 16A in a state of being surrounded by the frame 90, so that the two-dimensional image of interest 50A is in a state of being distinguishable from the remaining two-dimensional images 50 among the plurality of two-dimensional images 50. Consequently, a correspondence relationship between the two-dimensional image of interest 50A and the portion of interest 54A in the three-dimensional image 52 is in a state of being visually specifiable.

It should be noted that, in the example shown in FIG. 17, the portion of interest 54A in the three-dimensional image 52 is displayed on the screen 16A in an enlarged state. However, the entire three-dimensional image 52 may be displayed on the screen 16A in a size in which the entire three-dimensional image 52 is included in the third image region 83, and the portion of interest 54A in the three-dimensional image 52 may be displayed on the screen 16A in a state of being distinguishable from the remaining portions 54 by another aspect. For example, the portion of interest 54A may be displayed on the screen 16A in an aspect in which the portion of interest 54A is represented by a different color from the remaining portions 54, an aspect in which a pattern is added to the portion of interest 54A, an aspect in which the portion of interest 54A is surrounded by a frame, or an aspect in which the pixel forming the contour of the portion of interest 54A has higher brightness than the peripheral pixels. Even in such an example, the portion of interest 54A in the three-dimensional image 52 is in a state of being visually specifiable.

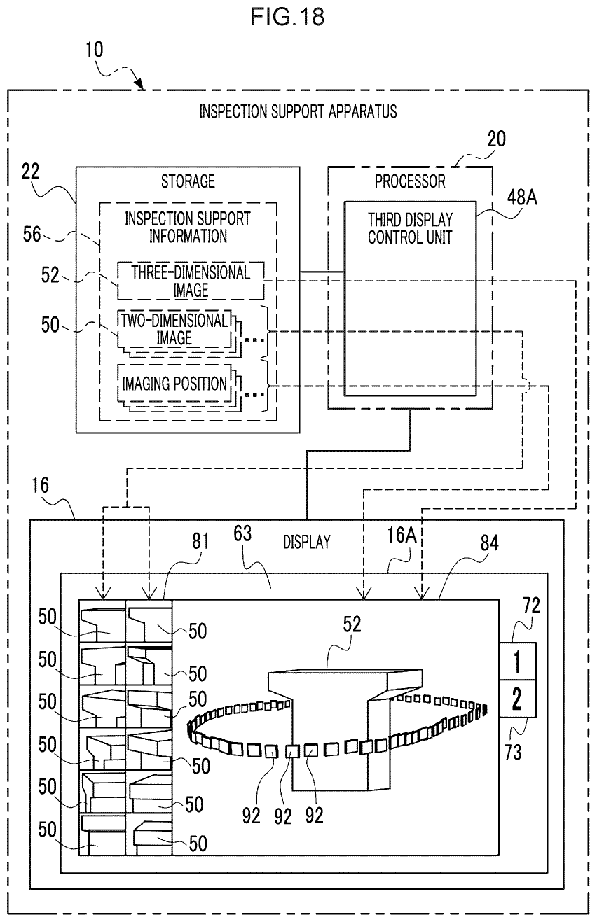

As an example, FIG. 18 shows a state in which the third image 63 is displayed on the screen 16A. The third image 63 includes the first image region 81 and a fourth image region 84. As an example, the first image region 81 and the fourth image region 84 are displayed on the screen 16A in a state of being arranged in a left-right direction of the third image 63. The first image region 81 is the same as the first image region 81 of the first image 61 (see FIG. 10). The fourth image region 84 includes the three-dimensional image 52 and a plurality of position specifying images 92. Each position specifying image 92 is an image for specifying the plurality of imaging positions at which the imaging for obtaining the plurality of two-dimensional images 50 is performed, and indicates the imaging position corresponding to each two-dimensional image 50.

The third display control unit 48A includes the plurality of two-dimensional images 50 in the first image region 81 based on the plurality of two-dimensional images 50 included in the inspection support information 56. In addition, the third display control unit 48A includes the three-dimensional image 52 in the fourth image region 84 based on the three-dimensional image 52 which is included in the inspection support information 56.

The three-dimensional image 52 is included in the fourth image region 84 in a state of being two-dimensionally imaged by rendering. For example, the size of the three-dimensional image 52 is changed by the inspector 6 giving the instruction to change the size of the three-dimensional image 52 to the reception device 14 (see FIG. 9). For example, the three-dimensional image 52 is rotated by the inspector 6 giving the instruction to rotate the three-dimensional image 52 to the reception device 14.

Further, the third display control unit 48A includes the plurality of position specifying images 92 in the fourth image region 84 based on each imaging position included in the inspection support information 56. Each position specifying image 92 is, for example, represented as a plate shape. The plurality of position specifying images 92 are included in the fourth image region 84 in a state in which the plurality of position specifying images 92 and the three-dimensional image 52 are comparable with each other. Specifically, the plurality of position specifying images 92 are disposed around the three-dimensional image 52, so that the plurality of position specifying images 92 are included in the fourth image region 84 in a state of facing the three-dimensional image 52. That is, the fourth image region 84 includes an image showing an aspect in which the plurality of position specifying images 92 and the three-dimensional image 52 face each other.

The first image region 81 and the fourth image region 84 are displayed in a state of being arranged on the screen 16A, so that the plurality of two-dimensional images 50 and the three-dimensional image 52 are in a state of being comparable with each other, and the plurality of two-dimensional images 50 and the plurality of position specifying images 92 are in a state of being comparable with each other.

It should be noted that, in the example shown in FIG. 18, the example is shown in which the first image region 81 and the fourth image region 84 are displayed on the screen 16A in a state of being arranged in the left-right direction of the third image 63. However, for example, the first image region 81 and the fourth image region 84 may be displayed on the screen 16A in a state of being arranged in an up-down direction of the third image 63, or the first image region 81 and the fourth image region 84 may be displayed on the screen 16A in a state in which the first image region 81 is incorporated into a part of the fourth image region 84.

The first image region 81 is an example of a “first region” and a “third region” according to the technology of the present disclosure. The fourth image region 84 is an example of a “second region” and a “fourth region” according to the technology of the present disclosure. The position specifying image 92 is an example of a “position specifying image” according to the technology of the present disclosure.

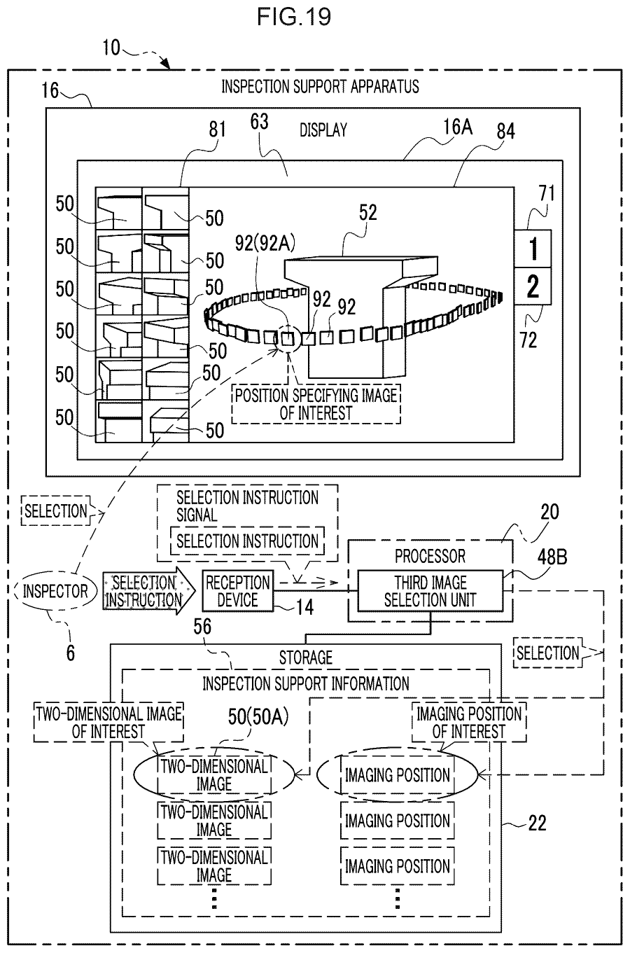

As shown in FIG. 19 as an example, in a case in which the selection instruction, which is the instruction to select any position specifying image 92 among the plurality of position specifying images 92 included in the fourth image region 84, is received by the reception device 14 in a state in which the third image 63 is displayed on the screen 16A, the reception device 14 outputs the selection instruction signal indicating the selection instruction to the processor 20. It should be noted that, hereinafter, the selected position specifying image 92 among the plurality of position specifying images 92 will be referred to as a “position specifying image of interest 92A”.

In a case in which the selection instruction signal is input to the processor 20, the third image selection unit 48B selects the imaging position (hereinafter, referred to as an “imaging position of interest”) corresponding to the position specifying image of interest 92A from among the plurality of imaging positions included in the inspection support information 56 in response to the selection instruction indicated by the selection instruction signal. Then, the third image selection unit 48B selects the two-dimensional image of interest 50A corresponding to the imaging position of interest from among the plurality of two-dimensional images 50 included in the inspection support information 56. The two-dimensional image of interest 50A is the two-dimensional image 50 obtained by being captured from the imaging position of interest. The position specifying image of interest 92A is an example of a “position specifying image of interest” according to the technology of the present disclosure. The imaging position of interest is an example of an “imaging position of interest” according to the technology of the present disclosure.

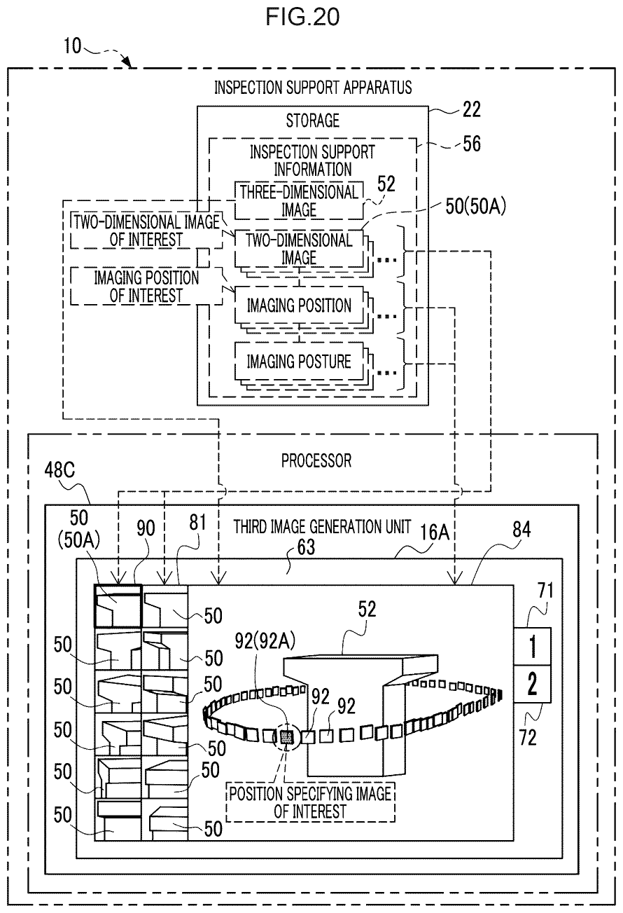

As shown in FIG. 20 as an example, the third image generation unit 48C generates the fourth image region 84 including the three-dimensional image 52 based on the three-dimensional image 52 included in the inspection support information 56. In addition, the third image generation unit 48C includes the plurality of position specifying images 92 in the fourth image region 84 based on the imaging position and the imaging posture which are included in the inspection support information 56. The plurality of position specifying images 92 are disposed around the three-dimensional image 52, so that the plurality of position specifying images 92 are included in the fourth image region 84 in a state of facing the three-dimensional image 52. Each position specifying image 92 is disposed at the posture corresponding to each imaging posture at each imaging position.

In addition, the third image generation unit 48C includes the position specifying image of interest 92A corresponding to the imaging position of interest among the plurality of position specifying images 92 in the fourth image region 84. The position specifying image of interest 92A is included in the fourth image region 84 in a state of being distinguishable from the remaining position specifying images 92 among the plurality of position specifying images 92. In the example shown in FIG. 20, as an example of a state in which the position specifying image of interest 92A is distinguishable from the remaining position specifying images 92, the position specifying image of interest 92A is represented by a different color from the remaining position specifying images 92. It should be noted that the position specifying image of interest 92A may be surrounded by a frame, or a pattern may be added to the position specifying image of interest 92A. In addition, the pixel forming the contour of the position specifying image of interest 92A may have a higher brightness than the surrounding pixels.

Further, the third image generation unit 48C includes the predetermined number of two-dimensional images 50 among the plurality of two-dimensional images 50 included in the inspection support information 56, and generates the first image region 81 in an aspect in which the two-dimensional image of interest 50A is surrounded by the frame 90.

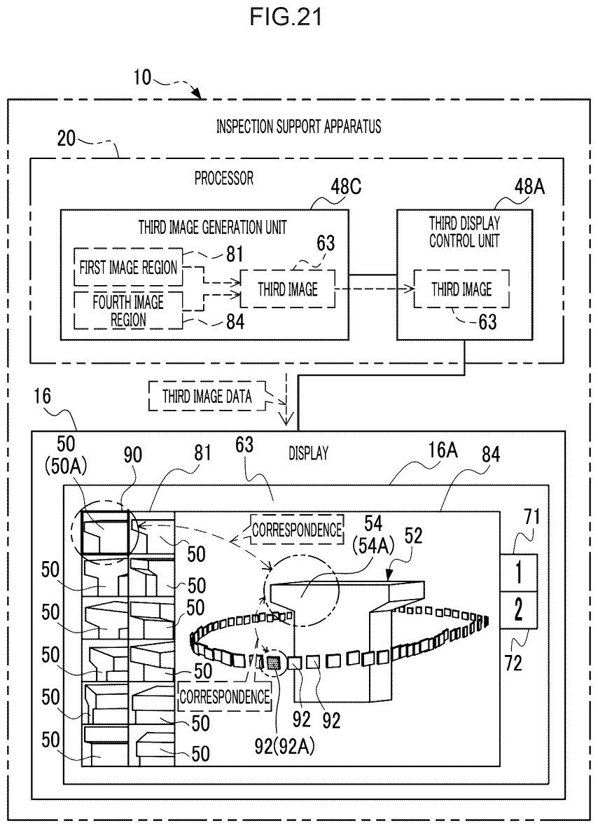

As shown in FIG. 21 as an example, the third image generation unit 48C generates the third image 63 by combining the first image region 81 and the fourth image region 84 which are generated.

The third display control unit 48A outputs third image data indicating the third image 63 generated by the third image generation unit 48C to the display 16. Consequently, the third image 63 is displayed on the screen 16A of the display 16. Specifically, the predetermined number of two-dimensional images 50 among the plurality of two-dimensional images 50 are displayed on the screen 16A in a state of being included in the first image region 81, and the two-dimensional image of interest 50A is displayed on the screen 16A in a state of being surrounded by the frame 90. Further, the three-dimensional image 52 is displayed on the screen 16A.

Further, the plurality of position specifying images 92 are displayed on the screen 16A in a state of being disposed around the three-dimensional image 52 to face the three-dimensional image 52, and the position specifying image of interest 92A is displayed on the screen 16A in a state of being distinguishable from the remaining position specifying images 92 among the plurality of position specifying images 92. The position specifying image of interest 92A is displayed on the screen 16A in a state of being distinguishable from the remaining position specifying images 92, so that the portion of interest 54A corresponding to the position specifying image of interest 92A in the three-dimensional image 52 is in a state of being visually specifiable. That is, the imaging position and the imaging posture are specified by the position specifying image of interest 92A, and a correspondence relationship between the imaging position and the imaging posture, which are specified, and the portion of interest 54A in the three-dimensional image 52 is in a state of being visually specifiable. Consequently, the portion of interest 54A in the three-dimensional image 52 is in a state of being visually specifiable.

In addition, the two-dimensional image of interest 50A is displayed on the screen 16A in a state of being surrounded by the frame 90, so that the two-dimensional image of interest 50A is in a state of being distinguishable from the remaining two-dimensional images 50 among the plurality of two-dimensional images 50. Consequently, a correspondence relationship between the two-dimensional image of interest 50A and the portion of interest 54A in the three-dimensional image 52 is in a state of being visually specifiable.

It should be noted that, in the example shown in FIG. 21, the entire three-dimensional image 52 is displayed on the screen 16A in a size in which the entire three-dimensional image 52 is included in the fourth image region 84. However, the portion of interest 54A in the three-dimensional image 52 may be displayed on the screen 16A in an enlarged state. Even in such an example, the portion of interest 54A in the three-dimensional image 52 is in a state of being visually specifiable.

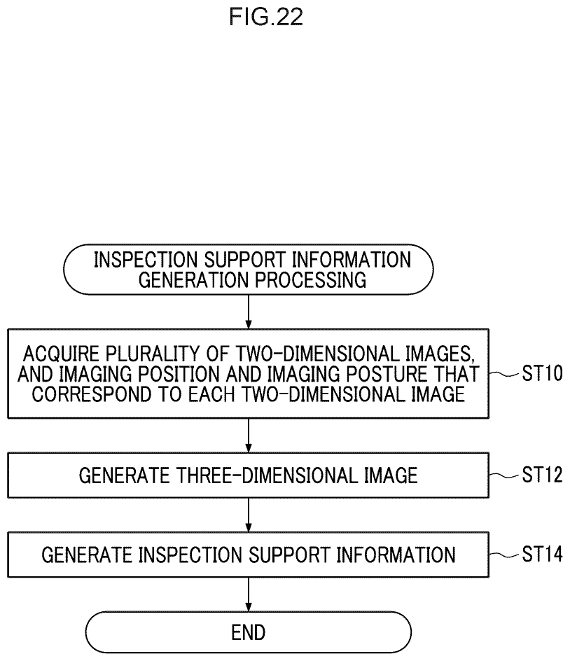

Next, operations of the inspection support apparatus 10 according to the first embodiment will be described with reference to FIGS. 22 to 26.

First, an example of a flow of the inspection support information generation processing performed by the processor 20 of the inspection support apparatus 10 will be described with reference to FIG. 22.

In the inspection support information generation processing shown in FIG. 22, first, in step ST10, the acquisition unit 32 (see FIG. 6) acquires the two-dimensional image 50 based on each image data received by the inspection support apparatus 10. In addition, the acquisition unit 32 acquires the imaging position corresponding to each two-dimensional image 50 based on each position data received by the inspection support apparatus 10. Further, the acquisition unit 32 acquires the imaging posture corresponding to each two-dimensional image 50 based on each posture data received by the inspection support apparatus 10. After the processing of step ST10 is executed, the inspection support information generation processing proceeds to step ST12.

In step ST12, the three-dimensional image generation unit 34 (see FIG. 6) generates the three-dimensional image 52 showing the target object 4 based on the plurality of two-dimensional images 50 acquired in step ST10. After the processing of step ST12 is executed, the inspection support information generation processing proceeds to step ST14.

In step ST14, the inspection support information generation unit 36 (see FIG. 7) generates the inspection support information 56 that is information in which each two-dimensional image 50 acquired in step ST10, the imaging position corresponding to each two-dimensional image 50, the imaging posture corresponding to each two-dimensional image 50, and the portion 54 corresponding to each two-dimensional image 50 are associated with each other. After the processing of step ST14 is executed, the inspection support information generation processing ends.

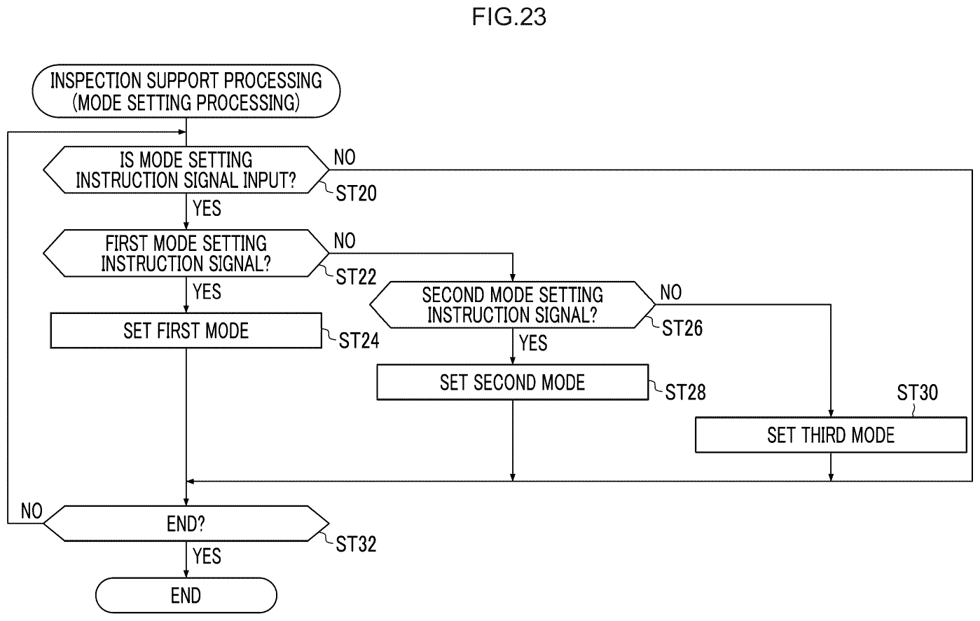

Next, an example of a flow of the inspection support processing performed by the processor 20 of the inspection support apparatus 10 will be described with reference to FIGS. 23 to 26. First, a flow of the mode setting processing in the inspection support processing will be described with reference to FIG. 23.

In the mode setting processing shown in FIG. 23, first, in step ST20, the operation mode setting unit 42 (see FIG. 9) determines whether the mode setting instruction signal is input to the processor 20. In step ST20, in a case in which the mode setting instruction signal is input to the processor 20, an affirmative determination is made, and the inspection support processing proceeds to step ST22. In step ST20, in a case in which the mode setting instruction signal is not input to the processor 20, a negative determination is made, and the mode setting processing proceeds to step ST32.

In step ST22, the operation mode setting unit 42 determines whether the mode setting instruction signal input to the processor 20 in step ST20 is the first mode setting instruction signal. In step ST22, in a case in which the mode setting instruction signal is the first mode setting signal, an affirmative determination is made, and the inspection support processing proceeds to step ST24. In step ST22, in a case in which the mode setting instruction signal is not the first mode setting signal, a negative determination is made, and the mode setting processing proceeds to step ST26.

In step ST24, the operation mode setting unit 42 sets the first mode as the operation mode of the inspection support apparatus 10. Consequently, the first mode processing is executed. After the processing of step ST24 is executed, the mode setting processing proceeds to step ST32.

In step ST26, the operation mode setting unit 42 determines whether the mode setting instruction signal input to the processor 20 in step ST20 is the second mode setting signal. In step ST26, in a case in which the mode setting instruction signal is the second mode setting signal, an affirmative determination is made, and the inspection support processing proceeds to step ST28. In step ST26, in a case in which the mode setting instruction signal is not the second mode setting signal, a negative determination is made, and the mode setting processing proceeds to step ST30.

In step ST28, the operation mode setting unit 42 sets the second mode as the operation mode of the inspection support apparatus 10. Consequently, the second mode processing is executed. After the processing of step ST28 is executed, the mode setting processing proceeds to step ST32.

In step ST30, the operation mode setting unit 42 sets the third mode as the operation mode of the inspection support apparatus 10. Consequently, the third mode processing is executed. After the processing of step ST30 is executed, the mode setting processing proceeds to step ST32.

In step ST32, the processor 20 determines whether a condition for ending the mode setting processing (hereinafter, referred to as a “mode setting processing end condition”) is met. Examples of the mode setting processing end condition include a condition in which an end instruction from the inspector 6 is received by the reception device 14, and an end instruction signal from the reception device 14 is input to the processor 20. In step ST32, in a case in which the mode setting processing end condition is not met, a negative determination is made, and the mode setting processing proceeds to step ST20. In step ST32, in a case in which the mode setting processing end condition is met, an affirmative determination is made, and the inspection support processing including the mode setting processing ends.

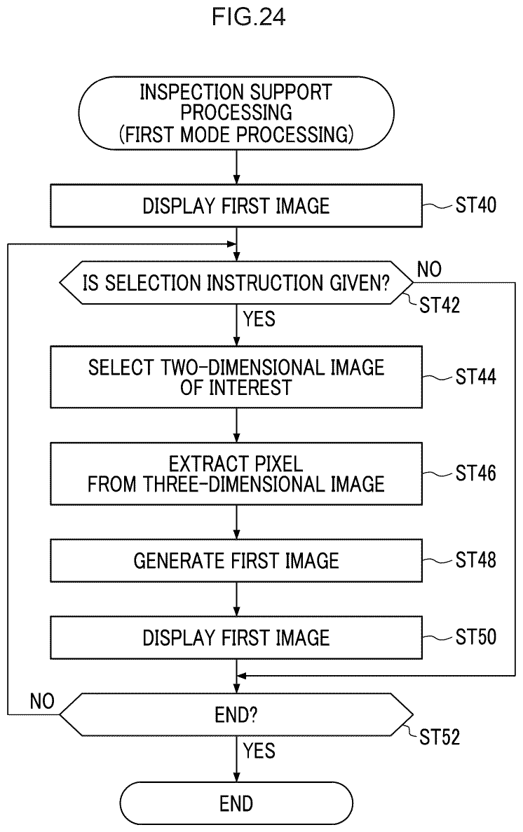

Next, an example of a flow of the first mode processing in the inspection support processing will be described with reference to FIG. 24.

In the first mode processing shown in FIG. 24, first, in step ST40, the first display control unit 44A (see FIG. 10) displays the first image 61 on the screen 16A. After the processing of step ST40 is executed, the first mode processing proceeds to step ST42.

In step ST42, the first image selection unit 44B (see FIG. 11) determines whether the selection instruction signal indicating the selection instruction, which is the instruction to select any two-dimensional image 50 among the plurality of two-dimensional images 50, is input to the processor 20. In step ST42, in a case in which the selection instruction signal indicating the selection instruction is input to the processor 20, an affirmative determination is made, and the first mode processing proceeds to step ST44. In step ST42, in a case in which the selection instruction signal indicating the selection instruction is not input to the processor 20, a negative determination is made, and the first mode processing proceeds to step ST52.

In step ST44, the first image selection unit 44B selects the two-dimensional image of interest 50A corresponding to the selection instruction indicated by the selection instruction signal, from among the plurality of two-dimensional images 50 included in the inspection support information 56. After the processing of step ST44 is executed, the first mode processing proceeds to step ST46.

In step ST46, the first pixel extraction unit 44C (see FIG. 12) acquires the imaging position and the imaging posture which correspond to the two-dimensional image of interest 50A selected in step ST44, from the inspection support information 56. Further, the first pixel extraction unit 44C derives the viewpoint corresponding to the two-dimensional image of interest 50A based on the acquired imaging position and imaging posture. Then, the first pixel extraction unit 44C extracts the pixel for including the three-dimensional image 52 in the second image region 82 at the derived viewpoint from the three-dimensional image 52 included in the inspection support information 56. After the processing of step ST46 is executed, the first mode processing proceeds to step ST48.

In step ST48, the first image generation unit 44D (see FIG. 12) includes the predetermined number of two-dimensional images 50 among the plurality of two-dimensional images 50 included in the inspection support information 56, and generates the first image region 81 in an aspect in which the two-dimensional image of interest 50A is surrounded by the frame 90. In addition, the first image generation unit 44D generates the second image region 82 including the three-dimensional image 52 having the size in which the entire three-dimensional image 52 is included in the second image region 82, at the viewpoint corresponding to the two-dimensional image of interest 50A based on the pixel extracted in step ST46. Then, the first image generation unit 44D (see FIG. 13) generates the first image 61 by combining the first image region 81 and the second image region 82 which are generated. After the processing of step ST48 is executed, the first mode processing proceeds to step ST50.

In step ST50, the first display control unit 44A (see FIG. 13) outputs the first image data indicating the first image 61 generated in step ST48 to the display 16. Consequently, the first image 61 is displayed on the screen 16A of the display 16. After the processing of step ST50 is executed, the first mode processing proceeds to step ST52.

In step ST52, the processor 20 determines whether a condition for ending the first mode processing (hereinafter, referred to as “first mode processing end condition”) is met. Examples of the first mode processing end condition include a condition in which an end instruction from the inspector 6 is received by the reception device 14, and an end instruction signal from the reception device 14 is input to the processor 20, and a condition in which the mode setting instruction signal indicating the instruction to set the operation mode different from the first mode is input to the processor 20. In step ST52, in a case in which the first mode processing end condition is not met, a negative determination is made, and the first mode processing proceeds to step ST42. In step ST52, in a case in which the first mode processing end condition is met, an affirmative determination is made, and the first mode processing ends.

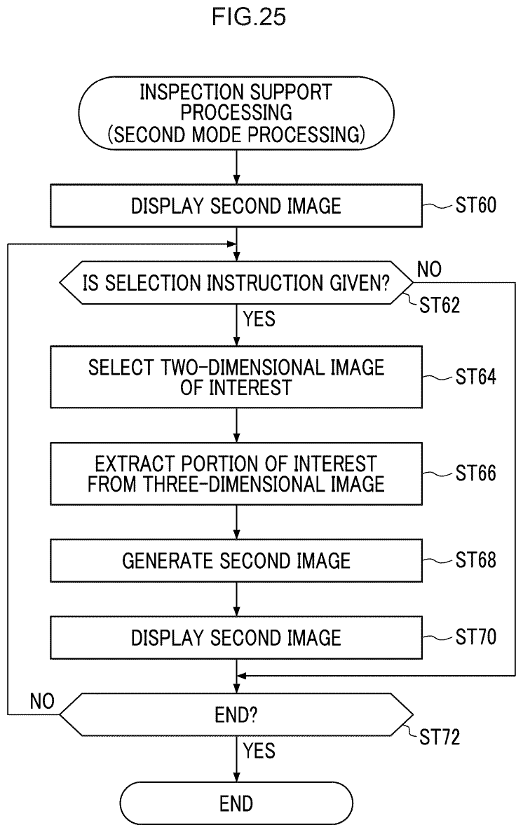

Next, an example of a flow of the second mode processing in the inspection support processing will be described with reference to FIG. 25.

In the second mode processing shown in FIG. 25, first, in step ST60, the second display control unit 46A (see FIG. 14) displays the second image 62 on the screen 16A. After the processing of step ST60 is executed, the second mode processing proceeds to step ST62.

In step ST62, the second image selection unit 46B (see FIG. 15) determines whether the selection instruction signal, which is the instruction to select any two-dimensional image 50 among the plurality of two-dimensional images 50, is input to the processor 20. In step ST62, in a case in which the selection instruction signal indicating the selection instruction is input to the processor 20, an affirmative determination is made, and the second mode processing proceeds to step ST64. In step ST62, in a case in which the selection instruction signal indicating the selection instruction is not input to the processor 20, a negative determination is made, and the second mode processing proceeds to step ST72.

In step ST64, the second image selection unit 46B selects the two-dimensional image of interest 50A corresponding to the selection instruction indicated by the selection instruction signal, from among the plurality of two-dimensional images 50 included in the inspection support information 56. After the processing of step ST64 is executed, the second mode processing proceeds to step ST66.

In step ST66, the second pixel extraction unit 46C (see FIG. 16) extracts the portion of interest 54A associated with the two-dimensional image of interest 50A from the three-dimensional image 52 included in the inspection support information 56. After the processing of step ST66 is executed, the second mode processing proceeds to step ST68.

In step ST68, the second image generation unit 46D (see FIG. 16) includes the predetermined number of two-dimensional images 50 among the plurality of two-dimensional images 50 included in the inspection support information 56, and generates the first image region 81 in an aspect in which the two-dimensional image of interest 50A is surrounded by the frame 90. In addition, the second image generation unit 46D generates the third image region 83 including the portion of interest 54A in the three-dimensional image 52 based on the portion of interest 54A extracted in step ST66. Then, the second image generation unit 46D (see FIG. 17) generates the second image 62 by combining the first image region 81 and the third image region 83 which are generated. After the processing of step ST68 is executed, the second mode processing proceeds to step ST70.

In step ST70, the second display control unit 46A (see FIG. 17) outputs the second image data indicating the second image 62 generated in step ST68 to the display 16. Consequently, the second image 62 is displayed on the screen 16A of the display 16. After the processing of step ST70 is executed, the second mode processing proceeds to step ST72.

In step ST72, the processor 20 determines whether a condition for ending the second mode processing (hereinafter, referred to as a “second mode processing end condition”) is met. Examples of the second mode processing end condition include a condition in which an end instruction from the inspector 6 is received by the reception device 14, and an end instruction signal from the reception device 14 is input to the processor 20, and a condition in which the mode setting instruction signal indicating the instruction to set the operation mode different from the second mode is input to the processor 20. In step ST72, in a case in which the second mode processing end condition is not met, a negative determination is made, and the second mode processing proceeds to step ST62. In step ST72, in a case in which the second mode processing end condition is met, an affirmative determination is made, and the second mode processing ends.

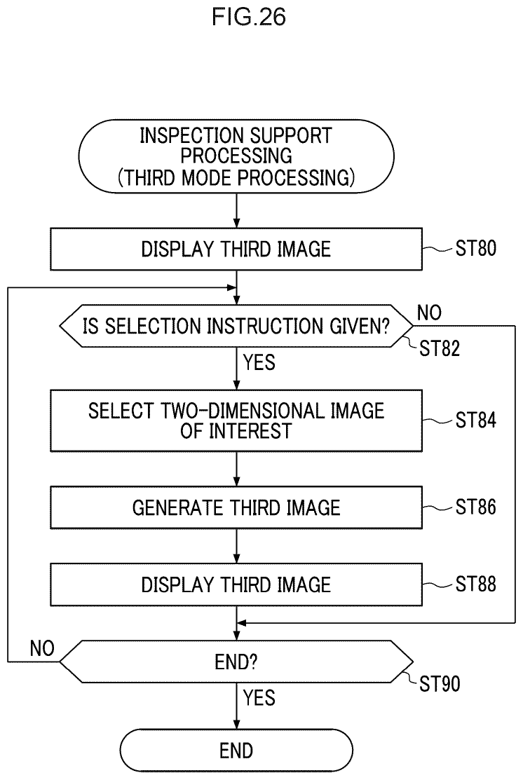

Next, an example of a flow of the third mode processing in the inspection support processing will be described with reference to FIG. 26.

In the third mode processing shown in FIG. 26, first, in step ST80, the third display control unit 48A (see FIG. 18) displays the third image 63 on the screen 16A. After the processing of step ST80 is executed, the third mode processing proceeds to step ST82.

In step ST82, the third image selection unit 48B (see FIG. 19) determines whether the selection instruction signal indicating the selection instruction, which is the instruction to select the position specifying image of interest 92A among the plurality of position specifying images 92, is input to the processor 20. In step ST82, in a case in which the selection instruction signal indicating the selection instruction is input to the processor 20, an affirmative determination is made, and the third mode processing proceeds to step ST84. In step ST82, in a case in which the selection instruction signal indicating the selection instruction is not input to the processor 20, a negative determination is made, and the third mode processing proceeds to step ST90.

In step ST84, the third image selection unit 48B selects the imaging position of interest corresponding to the position specifying image of interest 92A from among the plurality of imaging positions included in the inspection support information 56 in response to the selection instruction indicated by the selection instruction signal. Then, the third image selection unit 48B selects the two-dimensional image of interest 50A corresponding to the imaging position of interest from among the plurality of two-dimensional images 50 included in the inspection support information 56. After the processing of step ST84 is executed, the third mode processing proceeds to step ST86.

In step ST86, the third image generation unit 48C (see FIG. 20) generates the fourth image region 84 including the three-dimensional image 52 based on the three-dimensional image 52 included in the inspection support information 56. In addition, the third image generation unit 48C includes the plurality of position specifying images 92 in the fourth image region 84 based on the imaging position and the imaging posture which are included in the inspection support information 56. Further, the third image generation unit 48C includes the position specifying image of interest 92A corresponding to the imaging position of interest selected in step ST84, in the fourth image region 84. Then, the third image generation unit 48C (see FIG. 21) generates the third image 63 by combining the first image region 81 and the fourth image region 84 which are generated. After the processing of step ST86 is executed, the third mode processing proceeds to step ST88.

In step ST88, the third display control unit 48A (see FIG. 21) outputs the third image data indicating the third image 63 generated in step ST86 to the display 16. Consequently, the third image 63 is displayed on the screen 16A of the display 16. After the processing of step ST88 is executed, the third mode processing proceeds to step ST90.

In step ST90, the processor 20 determines whether a condition for ending the third mode processing (hereinafter, referred to as a “third mode processing end condition”) is met. Examples of the third mode processing end condition include a condition in which an end instruction from the inspector 6 is received by the reception device 14, and an end instruction signal from the reception device 14 is input to the processor 20, and a condition in which the mode setting instruction signal indicating the instruction to set the operation mode different from the third mode is input to the processor 20. In step ST90, in a case in which the third mode processing end condition is not met, a negative determination is made, and the third mode processing proceeds to step ST82. In step ST90, in a case in which the third mode processing end condition is met, an affirmative determination is made, and the third mode processing ends. It should be noted that the inspection support method described as the operation of the inspection support apparatus 10 is an example of an “image processing method” according to the technology of the present disclosure.

As described above, in the inspection support apparatus 10 according to the first embodiment, the processor 20 displays, on the screen 16A, the plurality of two-dimensional images 50 that are used to generate the three-dimensional image 52 showing the target object 4 in the real space and that are associated with the plurality of portions 54 of the three-dimensional image 52 in a state in which the plurality of two-dimensional images 50 and the three-dimensional image 52 are comparable with each other (see FIGS. 10, 14, and 18). In addition, the processor 20 selects the two-dimensional image of interest 50A from among the plurality of two-dimensional images 50 in response to the given selection instruction (see FIGS. 11, 15, and 19). Then, the processor 20 displays the portion of interest 54A corresponding to the two-dimensional image of interest 50A among the plurality of portions 54 on the screen 16A in a state in which the portion of interest 54A is visually specifiable (see FIGS. 13, 17, and 21). Therefore, it is possible to visually understand a correspondence relationship between each two-dimensional image 50 and the region in the target object 4 corresponding to each two-dimensional image 50.

In addition, the state in which the plurality of two-dimensional images 50 and the three-dimensional image 52 are comparable with each other is a state in which the first image region 81 including the plurality of two-dimensional images 50 and the image region including the three-dimensional image 52 (that is, the second image region 82, the third image region 83, or the fourth image region 84) are arranged (see FIGS. 10, 14, and 18). Therefore, the plurality of two-dimensional images 50 and the three-dimensional image 52 can be visually compared with each other.

In addition, the state in which the portion of interest 54A is visually specifiable includes a state in which the portion of interest 54A is distinguishable from the remaining portions 54 among the plurality of portions 54 (see FIGS. 17 and 21). Therefore, for example, the visibility of the portion of interest 54A can be enhanced as compared with a case in which the portion of interest 54A is not distinguished from the remaining portions 54.

In addition, the state in which the portion of interest 54A is visually specifiable includes a state in which the two-dimensional image of interest 50A is distinguishable from the remaining two-dimensional images 50 among the plurality of two-dimensional images 50 (see FIGS. 13, 17, and 21). Therefore, for example, the visibility of the portion of interest 54A can be enhanced as compared with a case in which the two-dimensional image of interest 50A is not distinguished from the remaining two-dimensional images 50. In addition, in a case in which the plurality of two-dimensional images 50 and the three-dimensional image 52 are displayed on the screen 16A in a state of being comparable with each other, and the portion of interest 54A is displayed on the screen 16A in a state of being distinguishable from the remaining portions 54 (see FIGS. 17 and 21), a correspondence relationship between the two-dimensional image of interest 50A and the portion of interest 54A can be visually specified.

In addition, the processor 20 displays, on the screen 16A, the plurality of position specifying images 92 in which the plurality of imaging positions at which the imaging for obtaining the plurality of two-dimensional images 50 is performed are specifiable, in a state in which the plurality of position specifying images 92 and the three-dimensional image 52 are comparable with each other (see FIG. 18). In addition, the processor 20 selects the imaging position corresponding to the position specifying image of interest 92A, which is selected from among the plurality of position specifying images 92, as the imaging position of interest from among the plurality of imaging positions in response to the selection instruction (see FIG. 19). Then, the processor 20 selects the two-dimensional image 50 obtained by performing the imaging from the imaging position of interest from among the plurality of two-dimensional images 50 as the two-dimensional image of interest 50A (see FIG. 19). Therefore, the two-dimensional image of interest 50A can be selected from among the plurality of two-dimensional images 50 by selecting the position specifying image of interest 92A from among the plurality of position specifying images 92.

In addition, the state in which the plurality of position specifying images 92 and the three-dimensional image 52 are comparable with each other includes a state in which the plurality of position specifying images 92 and the three-dimensional image 52 face each other (see FIG. 19). Therefore, the position specifying image of interest 92A corresponding to the portion of interest 54A in the three-dimensional image 52 can be selected from among the plurality of position specifying images 92 based on the state in which the plurality of position specifying images 92 and the three-dimensional image 52 face each other.

In addition, the state in which the plurality of two-dimensional images 50 and the three-dimensional image 52 are comparable with each other is a state in which the first image region 81 including the plurality of two-dimensional images 50 and the fourth image region 84 (that is, an image region including an image showing an aspect in which the plurality of position specifying images 92 and the three-dimensional image 52 face each other) are arranged (see FIGS. 18 and 19). Therefore, the plurality of two-dimensional images 50, the plurality of portions 54 in the three-dimensional image 52, and the plurality of position specifying images 92 can be visually compared with each other.

In addition, the state in which the portion of interest 54A is visually specifiable includes a state in which the position specifying image of interest 92A is distinguishable from the remaining position specifying images 92 among the plurality of position specifying images 92. Therefore, for example, the visibility of the portion of interest 54A can be enhanced as compared with a case in which the position specifying image of interest 92A is not distinguished from the remaining position specifying images 92.

In addition, the inspection support apparatus 10 (see FIG. 9) has the operation mode (for example, the first mode and the second mode) in which the plurality of two-dimensional images 50 and the three-dimensional image 52 are displayed on the screen 16A in a state in which the plurality of two-dimensional images 50 and the three-dimensional image 52 are comparable with each other, and the operation mode (that is, the third mode) in which the plurality of position specifying images 92 are displayed on the screen 16A in a state in which the plurality of position specifying images 92 and the three-dimensional image 52 are comparable with each other. Then, the processor 20 sets the operation mode in response to the given setting instruction. Therefore, for example, the screen 16A can be selectively switched, depending on the portion of interest 54A, between the state in which the plurality of two-dimensional images 50 and the three-dimensional image 52 are comparable with each other and the state in which the plurality of position specifying images 92 and the three-dimensional image 52 are comparable with each other.

In the first mode, the three-dimensional image 52 is displayed on the screen 16A from the viewpoint corresponding to the two-dimensional image of interest 50A (see FIG. 13). Therefore, the portion of interest 54A corresponding to the two-dimensional image of interest 50A among the plurality of portions 54 can be visually specified based on the viewpoint corresponding to the two-dimensional image of interest 50A.

It should be noted that the inspection support apparatus 10 according to the first embodiment has the first mode, the second mode, and the third mode, but any one operation mode of the first mode, the second mode, or the third mode may be omitted. The inspection support apparatus 10 according to the first embodiment may have only one operation mode of the first mode, the second mode, or the third mode.

### Second Embodiment

Next, a second embodiment of the present disclosure will be described.

In the second embodiment, the configuration of the inspection support apparatus 10 is changed from that of the first embodiment as follows.

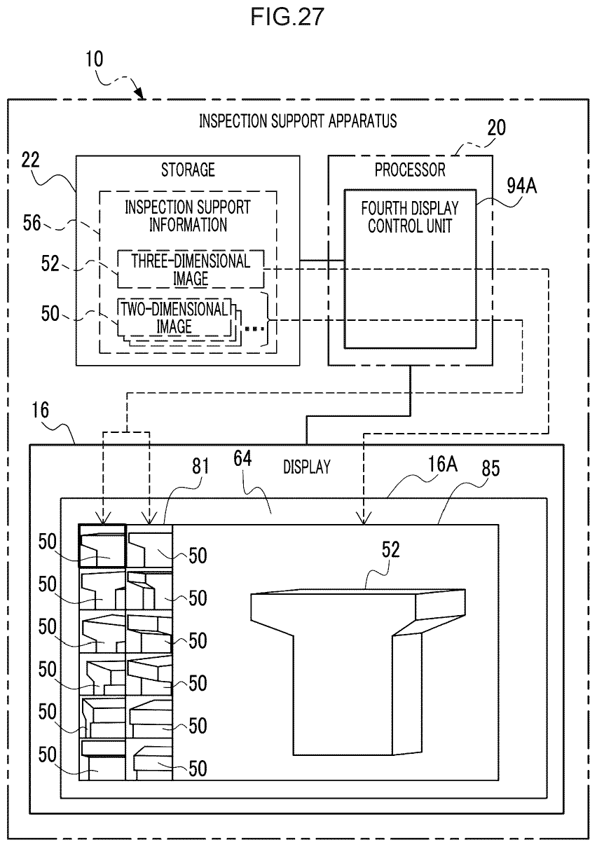

As an example, as shown in FIG. 27, the processor 20 operates as a fourth display control unit 94A. The fourth display control unit 94A displays a fourth image 64 on the screen 16A. The fourth image 64 includes the first image region 81 and a fifth image region 85. As an example, the first image region 81 and the fifth image region 85 are displayed on the screen 16A in a state of being arranged in a left-right direction of the fourth image 64. The first image region 81 is the same as the first image region 81 of the first image 61 (see FIG. 10). The fifth image region 85 includes the three-dimensional image 52.

The fourth display control unit 94A includes the plurality of two-dimensional images 50 in the first image region 81 based on the plurality of two-dimensional images 50 included in the inspection support information 56. The fourth display control unit 94A includes the three-dimensional image 52 in the fifth image region 85 based on the three-dimensional image 52 included in the inspection support information 56.

The three-dimensional image 52 is included in the fifth image region 85 in a state of being two-dimensionally imaged by rendering. For example, the size of the three-dimensional image 52 is changed by the inspector 6 giving the instruction to change the size of the three-dimensional image 52 to the reception device 14 (see FIG. 9). For example, the three-dimensional image 52 is rotated by the inspector 6 giving the instruction to rotate the three-dimensional image 52 to the reception device 14.

The first image region 81 including the plurality of two-dimensional images 50 and the fifth image region 85 including the three-dimensional image 52 are displayed on the screen 16A in a state of being arranged, so that the plurality of two-dimensional images 50 and the three-dimensional image 52 are in a state of being comparable with each other.

It should be noted that, in the example shown in FIG. 27, the example is shown in which the first image region 81 and the fifth image region 85 are displayed on the screen 16A in a state of being arranged in the left-right direction of the fourth image 64. However, for example, the first image region 81 and the fifth image region 85 may be displayed on the screen 16A in a state of being arranged in an up-down direction of the fourth image 64, or the first image region 81 and the fifth image region 85 may be displayed on the screen 16A in a state in which the first image region 81 is incorporated into a part of the fifth image region 85.

The first image region 81 is an example of a “first region” according to the technology of the present disclosure. The fifth image region 85 is an example of a “second region” according to the technology of the present disclosure.

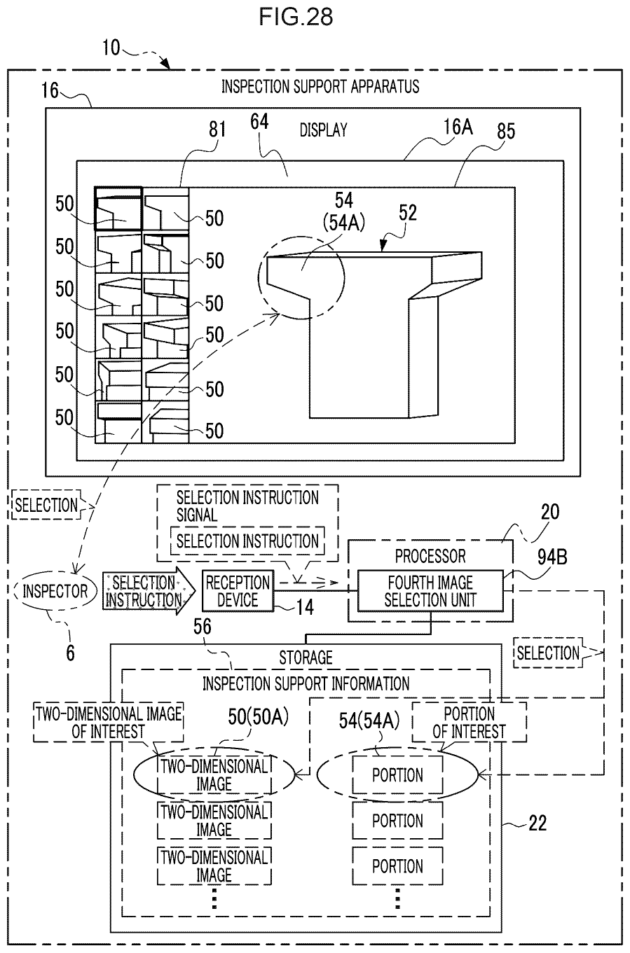

As shown in FIG. 28 as an example, in a case in which the selection instruction, which is the instruction to select any portion 54 in the three-dimensional image 52 included in the fifth image region 85, is received by the reception device 14 in a state in which the fourth image 64 is displayed on the screen 16A, the reception device 14 outputs the selection instruction signal indicating the selection instruction to the processor 20.

The processor 20 operates as a fourth image selection unit 94B. In a case in which the selection instruction signal is input to the processor 20, the fourth image selection unit 94B selects the portion 54 (that is, the portion of interest 54A) corresponding to the selection instruction from among the plurality of portions 54 included in the inspection support information 56 in response to the selection instruction indicated by the selection instruction signal. In addition, the fourth image selection unit 94B selects the two-dimensional image 50 (that is, the two-dimensional image of interest 50A) corresponding to the portion of interest 54A from among the plurality of two-dimensional images 50 included in the inspection support information 56.

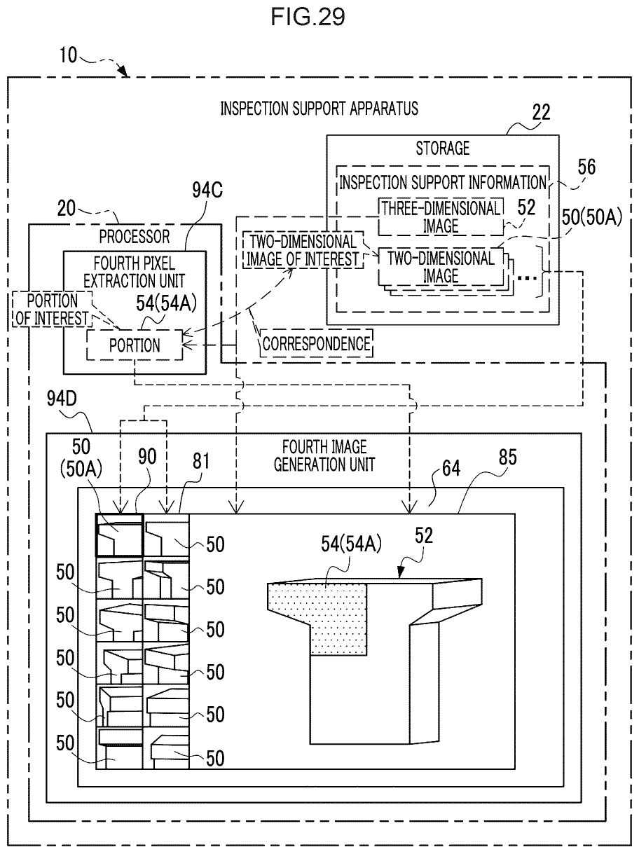

As an example, as shown in FIG. 29, the processor 20 operates as a fourth pixel extraction unit 94C and a fourth image generation unit 94D. The fourth pixel extraction unit 94C extracts the portion of interest 54A corresponding to the two-dimensional image of interest 50A from the three-dimensional image 52 included in the inspection support information 56.

The fourth image generation unit 94D includes the predetermined number of two-dimensional images 50 among the plurality of two-dimensional images 50 included in the inspection support information 56, and generates the first image region 81 in an aspect in which the two-dimensional image of interest 50A is surrounded by the frame 90. The fourth image generation unit 94D generates the fifth image region 85 including the three-dimensional image 52 based on the three-dimensional image 52 included in the inspection support information 56. Further, the fourth image generation unit 94D includes the portion of interest 54A extracted by the fourth pixel extraction unit 94C in the fifth image region 85 in a state in which the portion of interest 54A is distinguishable from the remaining portions 54. For example, the fourth image generation unit 94D includes the fifth image region 85 in an aspect in which the portion of interest 54A is represented by a different color from the remaining portions 54.

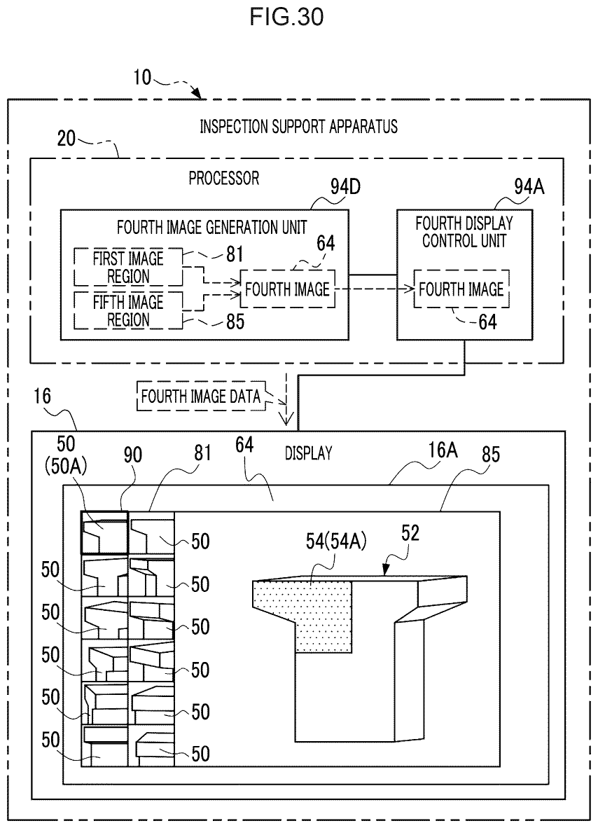

As shown in FIG. 30 as an example, the fourth image generation unit 94D generates the fourth image 64 by combining the first image region 81 and the fifth image region 85 which are generated.

The fourth display control unit 94A outputs fourth image data indicating the fourth image 64 generated by the fourth image generation unit 94D to the display 16. Consequently, the fourth image 64 is displayed on the screen 16A of the display 16. Specifically, the predetermined number of two-dimensional images 50 among the plurality of two-dimensional images 50 are displayed on the screen 16A in a state of being included in the first image region 81, and the two-dimensional image of interest 50A is displayed on the screen 16A in a state of being surrounded by the frame 90. The two-dimensional image of interest 50A is displayed on the screen 16A in a state of being surrounded by the frame 90, so that the two-dimensional image of interest 50A is in a state of being distinguishable from the remaining two-dimensional images 50 among the plurality of two-dimensional images 50.

In addition, the portion of interest 54A included in the three-dimensional image 52 is displayed on the screen 16A in a state in which the portion of interest 54A is distinguishable from the remaining portions 54. The portion of interest 54A is displayed on the screen 16A in a state in which the portion of interest 54A is distinguishable from the remaining portions 54, so that the portion of interest 54A in the three-dimensional image 52 is in a state of being visually specifiable.

It should be noted that, in the example shown in FIG. 30, the portion of interest 54A is displayed in a different color from the remaining portions 54. However, the portion of interest 54A may be displayed on the screen 16A in a state of being distinguishable from the remaining portions 54 by another aspect. For example, the portion of interest 54A may be displayed on the screen 16A in an aspect in which the portion of interest 54A is surrounded by a frame, an aspect in which a pattern is added to the portion of interest 54A, or an aspect in which the portion of interest 54A has higher brightness than the remaining portions 54. Even in such an example, the portion of interest 54A is in a state of being distinguishable from the remaining portions 54.

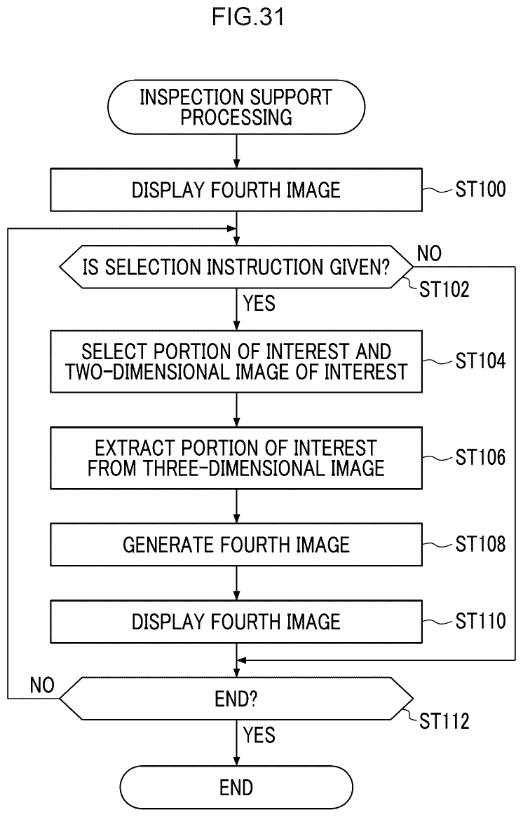

Next, an operation of the inspection support apparatus 10 according to the second embodiment will be described with reference to FIG. 31. FIG. 31 shows an example of a flow of inspection support processing according to the second embodiment.

In the inspection support processing shown in FIG. 31, first, in step ST100, the fourth display control unit 94A (see FIG. 27) displays the fourth image 64 on the screen 16A. After the processing of step ST100 is executed, the inspection support processing proceeds to step ST102.

In step ST102, the fourth image selection unit 94B (see FIG. 28) determines whether the selection instruction signal indicating the selection instruction, which is the instruction to select any portion 54 in the three-dimensional image 52, is input to the processor 20. In step ST102, in a case in which the selection instruction signal indicating the selection instruction is input to the processor 20, an affirmative determination is made, and the inspection support processing proceeds to step ST104. In step ST102, in a case in which the selection instruction signal indicating the selection instruction is not input to the processor 20, a negative determination is made, and the inspection support processing proceeds to step ST112.

In step ST104, the fourth image selection unit 94B selects the portion of interest 54A corresponding to the selection instruction indicated by the selection instruction signal from among the plurality of portions 54 included in the inspection support information 56. In addition, the fourth image selection unit 94B selects the two-dimensional image of interest 50A corresponding to the portion of interest 54A from among the plurality of two-dimensional images 50 included in the inspection support information 56. After the processing of step ST104 is executed, the inspection support processing proceeds to step ST106.

In step ST106, the fourth pixel extraction unit 94C (see FIG. 29) extracts the portion of interest 54A corresponding to the two-dimensional image of interest 50A from the three-dimensional image 52 included in the inspection support information 56. After the processing of step ST106 is executed, the inspection support processing proceeds to step ST108.

In step ST108, the fourth image generation unit 94D (see FIG. 30) includes the predetermined number of two-dimensional images 50 among the plurality of two-dimensional images 50 included in the inspection support information 56, and generates the first image region 81 in an aspect in which the two-dimensional image of interest 50A is surrounded by the frame 90. The fourth image generation unit 94D generates the fifth image region 85 including the three-dimensional image 52 based on the three-dimensional image 52 included in the inspection support information 56. Further, the fourth image generation unit 94D includes the portion of interest 54A extracted in step ST106 in the fifth image region 85 in a state in which the portion of interest 54A is distinguishable from the remaining portions 54. Then, the fourth image generation unit 94D generates the fourth image 64 by combining the first image region 81 and the fifth image region 85 which are generated. After the processing of step ST108 is executed, the inspection support processing proceeds to step ST110.

In step ST110, the fourth display control unit 94A (see FIG. 30) outputs the fourth image data indicating the fourth image 64 generated in step ST108 to the display 16. Consequently, the fourth image 64 is displayed on the screen 16A of the display 16. After the processing of step ST110 is executed, the inspection support processing proceeds to step ST112.

In step ST112, the processor 20 determines whether a condition for ending the inspection support processing (hereinafter, referred to as an “end condition”) is met. Examples of the end condition include a condition in which an end instruction from the inspector 6 is received by the reception device 14, and an end instruction signal from the reception device 14 is input to the processor 20. In step ST112, in a case in which the end condition is not met, a negative determination is made, and the inspection support processing proceeds to step ST102. In step ST112, in a case in which the end condition is met, an affirmative determination is made, and the inspection support processing ends.

As described above, in the inspection support apparatus 10 according to the second embodiment, the processor 20 displays, on the screen 16A, the plurality of two-dimensional images 50 that are used to generate the three-dimensional image 52 showing the target object 4 in the real space and that are associated with the plurality of portions 54 of the three-dimensional image 52 in a state in which the plurality of two-dimensional images 50 and the three-dimensional image 52 are comparable with each other (see FIG. 27). In addition, the processor 20 selects the portion of interest 54A from among the plurality of portions 54 and selects the two-dimensional image of interest 50A corresponding to the portion of interest 54A from among the plurality of two-dimensional images 50 in response to the given selection instruction (see FIG. 28). Then, the processor 20 displays the two-dimensional image of interest 50A on the screen 16A in a state in which the two-dimensional image of interest 50A is distinguishable from the remaining two-dimensional images 50 among the plurality of two-dimensional images 50. Therefore, it is possible to visually understand a correspondence relationship between each two-dimensional image 50 and the region in the target object 4 corresponding to each two-dimensional image 50.

In addition, the processor 20 displays the portion of interest 54A on the screen 16A in a state of being visually specifiable (see FIG. 30). Therefore, a correspondence relationship between the two-dimensional image of interest 50A and the portion of interest 54A can be visually specified.

In addition, the state in which the portion of interest 54A is visually specifiable includes a state in which the portion of interest 54A is distinguishable from the remaining portions 54 among the plurality of portions 54 (see FIG. 30). Therefore, for example, the visibility of the portion of interest 54A can be enhanced as compared with a case in which the portion of interest 54A is not distinguished from the remaining portions 54.

It should be noted that the operation mode of the inspection support apparatus 10 according to the second embodiment may be added as a fourth mode to the operation mode of the inspection support apparatus 10 according to the first embodiment.

Further, the processor 20 is shown in the embodiment described above, but at least one CPU, at least one GPU, and/or at least one TPU may be used instead of the processor 20 or together with the processor 20.

In addition, in the embodiment described above, the form example is described in which the inspection support information generation program 30 and the inspection support program 40 are stored in the storage 22, but the technology of the present disclosure is not limited to this. The inspection support information generation program 30 and/or the inspection support program 40 may be stored in, for example, a portable non-transitory computer-readable storage medium, such as an SSD or a USB memory (hereinafter, simply referred to as a “non-transitory storage medium”). The inspection support information generation program 30 and/or the inspection support program 40 stored in the non-transitory storage medium may be installed in the computer 12 of the inspection support apparatus 10.

In addition, the inspection support information generation program 30 and/or the inspection support program 40 may be stored in a storage device of another computer, a server device, or the like connected to the inspection support apparatus 10 via a network, and the inspection support information generation program 30 and/or the inspection support program 40 may be downloaded in response to a request of the inspection support apparatus 10 and installed in the computer 12.

In addition, it is not necessary to store all of the inspection support information generation program 30 and/or the inspection support program 40 in the storage device of the other computer or in the server device connected to the inspection support apparatus 10 or in the storage 22, and a part of the inspection support information generation program 30 and/or the inspection support program 40 may be stored.

In addition, although the computer 12 is built in the inspection support apparatus 10, the technology of the present disclosure is not limited to this, and, for example, the computer 12 may be provided outside the inspection support apparatus 10.

In addition, in the embodiment described above, although the computer 12 including the processor 20, the storage 22, and the RAM 24 is shown, the technology of the present disclosure is not limited to this, and a device including an ASIC, an FPGA, and/or a PLD may be applied instead of the computer 12. Also, a combination of a hardware configuration and a software configuration may be used instead of the computer 12.

Further, the following various processors can be used as a hardware resource for executing the various types of processing described in the embodiment described above. Examples of the processor include a CPU which is a general-purpose processor functioning as the hardware resource for executing the various types of processing by executing software, that is, a program. Moreover, examples of the processor include a dedicated electronic circuit which is a processor having a circuit configuration designed to be dedicated for executing specific processing, such as the FPGA, the PLD, or the ASIC. Any processor includes a memory built therein or connected thereto, and any processor uses the memory to execute various types of processing.

The hardware resource for executing various types of processing may be configured by one of the various processors or may be configured by a combination of two or more processors that are the same type or different types (for example, combination of a plurality of FPGAs or combination of a CPU and an FPGA). Further, the hardware resource for executing the various types of processing may be one processor.

As a configuration example of one processor, first, there is a form in which one processor is configured by a combination of one or more CPUs and software and the processor functions as the hardware resource for executing the various types of processing. Secondly, as represented by an SoC, there is a form in which a processor that implements the functions of the entire system including a plurality of hardware resources for executing various types of processing with one IC chip is used. As described above, the various types of processing are implemented by using one or more of the various processors as the hardware resource.

Further, specifically, an electronic circuit obtained by combining circuit elements, such as semiconductor elements, can be used as the hardware structure of the various processors. In addition, the processing described above is merely an example. Accordingly, it goes without saying that unnecessary steps may be deleted, new steps may be added, or the processing order may be changed within a range that does not deviate from the gist.

The contents described and shown above are detailed descriptions of portions related to the technology of the present disclosure and are merely examples of the technology of the present disclosure. For example, the descriptions of the configurations, functions, operations, and effects are the descriptions of examples of the configurations, functions, operations, and effects of the portions related to the technology of the present disclosure. Therefore, it goes without saying that unnecessary portions may be deleted or new elements may be added or replaced in the contents described and shown above, without departing from the gist of the technology of the present disclosure. In addition, the description of, for example, common technical knowledge that does not need to be particularly described to enable the implementation of the technology of the present disclosure is omitted in the contents described and shown above in order to avoid confusion and to facilitate the understanding of the portions related to the technology of the present disclosure.

In the present specification, “A and/or B” is synonymous with “at least one of A or B”. That is, “A and/or B” means that it may be only A, only B, or a combination of A and B. In addition, in the present specification, in a case in which three or more matters are associated and expressed by “and/or”, the same concept as “A and/or B” is applied.

All of the documents, the patent applications, and the technical standards described in the specification are incorporated by reference herein to the same extent as each individual document, each patent application, and each technical standard is specifically and individually stated to be incorporated by reference.

What is claimed is:

1. An image processing apparatus comprising:
a processor,
wherein the processor is configured to:
display, on a screen, a plurality of two-dimensional images that are used to generate a three-dimensional image showing a target object in a real space and that are associated with a plurality of portions of the three-dimensional image, and the three-dimensional image in a state in which the plurality of two-dimensional images and the three-dimensional image are comparable with each other;
select a two-dimensional image of interest from among the plurality of two-dimensional images in response to a given selection instruction; and
display, on the screen, a portion of interest corresponding to the two-dimensional image of interest among the plurality of portions in a state in which the portion of interest is visually specifiable.

2. The image processing apparatus according to claim 1,
wherein the state in which the plurality of two-dimensional images and the three-dimensional image are comparable with each other is a state in which a first region including the plurality of two-dimensional images and a second region including the three-dimensional image are arranged.

3. The image processing apparatus according to claim 1,
wherein the state in which the portion of interest is visually specifiable includes a state in which the portion of interest is distinguishable from remaining portions among the plurality of portions.

4. The image processing apparatus according to claim 1,
wherein the state in which the portion of interest is visually specifiable includes a state in which the two-dimensional image of interest is distinguishable from remaining two-dimensional images among the plurality of two-dimensional images.

5. The image processing apparatus according to claim 1,
wherein the processor is configured to:
display, on the screen, a plurality of position specifying images in which a plurality of imaging positions at which imaging for obtaining the plurality of two-dimensional images is performed are specifiable, in a state in which the plurality of position specifying images and the three-dimensional image are comparable with each other;
select an imaging position corresponding to a position specifying image of interest, which is selected from among the plurality of position specifying images, as an imaging position of interest from among the plurality of imaging positions in response to the selection instruction; and
select a two-dimensional image obtained by performing the imaging from the imaging position of interest as the two-dimensional image of interest from among the plurality of two-dimensional images.

6. The image processing apparatus according to claim 5,
wherein the state in which the plurality of position specifying images and the three-dimensional image are comparable with each other includes a state in which the plurality of position specifying images and the three-dimensional image face each other.

7. The image processing apparatus according to claim 5,
wherein the state in which the plurality of two-dimensional images and the three-dimensional image are comparable with each other is a state in which a third region including the plurality of two-dimensional images and a fourth region including an image showing an aspect in which the plurality of position specifying images and the three-dimensional image face each other are arranged.

8. The image processing apparatus according to claim 5,
wherein the state in which the portion of interest is visually specifiable includes a state in which the position specifying image of interest is distinguishable from remaining position specifying images among the plurality of position specifying images.

9. The image processing apparatus according to claim 5,
wherein the image processing apparatus has a first operation mode in which the plurality of two-dimensional images and the three-dimensional image are displayed on the screen in the state in which the plurality of two-dimensional images and the three-dimensional image are comparable with each other, and a second operation mode in which the plurality of position specifying images are displayed on the screen in the state in which the plurality of position specifying images and the three-dimensional image are comparable with each other, and
the processor is configured to set any operation mode of the first operation mode or the second operation mode in response to a given setting instruction.

10. The image processing apparatus according to claim 5,
wherein the three-dimensional image is displayed on the screen from a viewpoint corresponding to the two-dimensional image of interest.

11. An image processing apparatus comprising:
a processor,
wherein the processor is configured to:
display, on a screen, a plurality of two-dimensional images that are used to generate a three-dimensional image showing a target object in a real space and that are associated with a plurality of portions of the three-dimensional image, and the three-dimensional image in a state in which the plurality of two-dimensional images and the three-dimensional image are comparable with each other;
select a portion of interest from among the plurality of portions in response to a given selection instruction;
select a two-dimensional image of interest corresponding to the portion of interest from among the plurality of two-dimensional images; and
display, on the screen, the plurality of two-dimensional images in a state in which the two-dimensional image of interest is distinguishable from remaining two-dimensional images among the plurality of two-dimensional images.

12. The image processing apparatus according to claim 11,
wherein the processor is configured to:
display, on the screen, a plurality of position specifying images in which a plurality of imaging positions at which imaging for obtaining the plurality of two-dimensional images is performed are specifiable, in a state in which the plurality of position specifying images and the three-dimensional image are comparable with each other;
select a position specifying image of interest from among the plurality of position specifying images in response to the selection instruction; and
select the two-dimensional image obtained by performing the imaging from the imaging position specified from the position specifying image of interest as the two-dimensional image of interest from among the plurality of two-dimensional images.

13. An image processing method comprising:
displaying, on a screen, a plurality of two-dimensional images that are used to generate a three-dimensional image showing a target object in a real space and that are associated with a plurality of portions of the three-dimensional image, and the three-dimensional image in a state in which the plurality of two-dimensional images and the three-dimensional image are comparable with each other;
selecting a two-dimensional image of interest from among the plurality of two-dimensional images in response to a given selection instruction; and
displaying, on the screen, a portion of interest corresponding to the two-dimensional image of interest among the plurality of portions in a state in which the portion of interest is visually specifiable.

14. A non-transitory computer-readable storage medium storing a program for causing a computer to execute a process comprising:
displaying, on a screen, a plurality of two-dimensional images that are used to generate a three-dimensional image showing a target object in a real space and that are associated with a plurality of portions of the three-dimensional image, and the three-dimensional image in a state in which the plurality of two-dimensional images and the three-dimensional image are comparable with each other;
selecting a two-dimensional image of interest from among the plurality of two-dimensional images in response to a given selection instruction; and
displaying, on the screen, a portion of interest corresponding to the two-dimensional image of interest among the plurality of portions in a state in which the portion of interest is visually specifiable.
